(19) United States
(12) Patent Application Publication
(10) Pub. No.: US 2025/0272652 A1
(43) Pub. Date: Aug. 28, 2025

(54) LARGE LANGUAGE MODEL (LLM) FOR ENTERPRISE APPLICATIONS DEVELOPED BY CODELESS PLATFORM

(71) Applicant: NB Ventures, Inc. DBA GEP, Clark, NJ (US)

(72) Inventors: Subhash Makhija, Westfield, NJ (US); Saratendu Sethi, Apex, NC (US); Pooja Patel, Mumbai (IN); Vinayak Agashe, Irving, TX (US); Balasubramaniyan Balakumar, Plano, TX (US); Bogdan Nadisan, Cluj-Napoca (RO); Neha Pahwa, Scarsdale, NY (US); Anil Kumar Kodali, Austin, TX (US); Nizar Dayani, Thane (IN)

(21) Appl. No.: 18/585,728

(22) Filed: Feb. 23, 2024

(51) Int. Cl. G06Q 10/087; G06F 3/0484; G06F 40/205; G06F 40/35; G06F 40/40

(52) U.S. Cl. CPC G06Q 10/087; G06F 3/0484; G06F 40/205; G06F 40/35; G06F 40/40

(57) ABSTRACT

The present invention provides a large language model-based system and method for data processing in application developed by codeless platform. The invention includes identification of intent of a user to process procurement, supply chain, application integration, application restructuring or development scenarios.

### BACKGROUND

### 1. Technical Field

The present invention relates generally to data processing. More particularly, the invention relates to large language models-based data processing in one or more enterprise applications including procurement and supply chain applications developed by codeless platform.

### 2. Description of the Prior Art

Traditional Enterprise applications including procurement and supply Chain applications cater to support collaboration between limited parties at any node in the enterprise application. In modern enterprise applications the number of parties involved has increased significantly with each of the parties being a specialist in the niche function they perform. Further, the existing enterprise applications dealing with multiple parties make the process cumbersome, time-consuming, and require manual intervention while dealing with complex scenarios. They frequently entail several channels, intricate workflows and human intervention leading to inefficiency which results in errors, delays, escalated expenditure, maverick spend and in turn increased cost of procurement. The rise of artificial intelligence (AI) has offered promising solutions to streamline enterprise application functions, with natural language processing (NLP) playing a key role in enabling human-like communication. However, existing solutions often lack the context awareness, adaptability, and conversational fluency needed for a truly autonomous experience.

Large language models perform various natural language processing (NLP) tasks with vast amounts of data. For any enterprise, data is extremely critical but more importantly meaningful data is of extreme value as it helps in decision making related to vital functions. To meet any operational requirement in an enterprise application, the ease in enabling the system to process information plays a critical role. The interaction of a user with the computing system in trying to execute the most complex tasks seamlessly is the growing need of the hour. While identification of intent of the user for determining the task to be executed is critical, the complexity of the nature of the task makes it extremely challenging and technically cumbersome to implement.

Enterprise application developed based on codeless platform present additional challenges while dealing with real time data processing. The complexity in structuring an application is technically challenging and impractical for a non-technical individual not familiar with programming concepts and paradigms to even understand the requirement. While certain aspects of application development may be addressed through user friendly interface, the complexity of tasks in enterprise applications related to procurement and supply chain makes it cumbersome to meet the requirement. The architecture of the codeless platform remains unsupportive in multiple aspects including working with different data abstraction. Moreover, for the computer to understand varied requirements of the user accurately is a big challenge.

None of the prior arts address the processing complexity and technical limitations in executing tasks associated with an enterprise application that are developed by codeless platform. Moreover, implementation of large language models for such enterprise applications developed by codeless platform are non-existent due the unknows and the existing complexity in data processing for deriving meaningful insights to enable execution of the required enterprise application function. Further, while scalability of the processing capability of existing computing resources while dealing with large language model is extremely challenging, such scaling in case of multiple large language models interacting to execute an enterprise function is even more cumbersome. Furthermore, existing data processing techniques for identification of intent of a user to understand the requirement and accordingly restructure the workflow, data processing steps and deal with the unknows is extremely limited and non-existent due to the varied requirements.

In view of the above problems, there is a need for a data processing system and method that can overcome the problems associated with the prior arts.

### SUMMARY

According to an embodiment, the present invention provides a system and method for large language model-based data processing in one or more applications developed by codeless development platform. The data processing comprises generating by a processing device, a graphical user interface (GUI) having a conversational assistant configured for receiving at least one input from a user. The method includes determining an intent of the user based on one or more data objects identified from the received input where the conversation assistant is configured to generate one or more query in response to the received input until the intent of the user is identified by an intent analyzer, triggering one or more LLM (large language model) agent for executing at least one task associated with the identified intent of the user wherein a process orchestrator invokes one or more tools identified by the LLM agent for executing the at least one task. The data processing method includes generating on the GUI, one or more graphical elements depicting one or more actionable data points associated with the executed task.

In an embodiment, the intent analyzer is a bot configured to parse the intent of the user based on the identified data objects and mapping the intent with the LLM agent, wherein one or more one data scripts are identified based on the parsed intent to trigger the at least one task.

In an embodiment, the data processing system and method includes a bot builder configured to process one or more historical data for generating and storing, training artifacts and flow artifacts in an intent database. The intent analyzer processes the received input based on one or more intent data models to identify the intent.

In a related embodiment, the intent analyzer is configured to analyze the intent from the at least one received input by converting the received input into numerical representation through embeddings, creating embeddings, one or more clusters during training and receiving sample prompts from users where each cluster represents a different intent. The intent analyzer identifies cluster nearest to an embedding representation of the received input to determine the intent, where a generative AI based reasoning model enables mapping of the received input to the intent in case the embedding representation is equally close to different clusters.

In an embodiment, parsing intent of the user includes predicting one or more procurement scenarios, supply chain scenarios, application integration scenarios, application restructuring or application development scenarios intended to be executed by the user as the at least one task, the bot identifies one or more nodes of a data network linked to the at least one task for parsing the intent.

In an embodiment, the system and method of the invention includes processing by an AI engine coupled to a processor, a plurality of historical procurement and user activity data from a data lake based on one or more procurement data models to generate code for a recommended strategy to execute the at least one task through prediction analysis.

In an embodiment, the data processing method of the invention includes injecting by an intelligent bot, aggregated user activity data and procurement data patterns related to one or more procurement categories into the recommended strategy. The method includes identifying one or more suppliers for executing the recommended strategy and encapsulating one or more recommended supplier awarding scenario on the GUI for selection.

In an embodiment, for the one or more application integration scenarios, the method includes identifying one or more entities, one or more application integration parameters, and the one or more integration data models from the data object for executing the at least one task of integration the one or more applications.

In a related embodiment, the data processing method for one or more application integration scenarios includes identifying source and target for executing the at least one task by automapping. The includes loading source and target files of syntax based structured data and extracting source path from a historical structured data database, and tokenizing source path and fetching matching target paths from Inverted Index supported historical database for automapping source and target.

In a related embodiment, matching of target paths includes converting each object of source to vector by word embedding, computing dot products and magnitude of the vectors to determine similarity, and determining similarity score for each object of target.

In another related embodiment, in response to determination of the application for integrations, generating one or more integration workflows by an intelligent bot, identifying by the bot, one or more configuration parameters for integration, and injecting by the bot, the configuration parameters into the one or more integration workflows for creating and deploying integration of the applications.

In an embodiment, the data processing method for application restructuring scenarios includes determining, by a processor, a requirement to restructure the one or more applications developed by a codeless platform as the at least one task, identifying by the one or more tools, one or more logical flow blocks to be invoked by the processor for creating one or more SCM application operation logical fragments configured to restructure the one or more applications, triggering a syntax data library by the processor, to enable the one or more tools to load one or more data library components on an extension tool interface for structuring the one or more logical flow blocks to create the one or more SCM application operation logical fragments, and restructuring the one or more applications by the one or more SCM application operation logical fragments to enable execution of at least one SCM application operation.

In a related embodiment, the data processing method for application development includes determining by a processor, a requirement to create one or more applications as the at least one task, wherein the one or more application is developed by a codeless platform. The method includes identifying by one or more tools, a plurality of configurable components invoked by the processor to be structured on a user interface for creating the one or more application, wherein the plurality of configurable components interacts through an application process orchestrator for executing the at least one task.

In an exemplary embodiment, the conversation assistant of the invention is configured to recommend one or more templates or components for customization of the one or more application, define data structures, relationships and rules, data models and validation rules, in response to a request for creating a user interface, recommend one or more interface components and generate a corresponding code for execution, and recommend data patterns and explain behavior and effects of different orchestrations.

The codeless platform includes a plurality of configurable components, a customization layer, an application layer, a shared framework layer, a foundation layer, a data layer and a application orchestrator, wherein the at least one processor is configured to cause the plurality of configurable components to interact with each other in a layered architecture to customize the one or more application based on at least one operation to be executed using the customization layer, organize at least one application service of the one or more application by causing the application layer to interact with the customization layer through one or more configurable components of the plurality of configurable components, wherein the application layer is configured to organize the at least one application service of the one or more application, fetch shared data objects to enable execution of the at least one application service by causing the shared framework layer to communicate with the application layer through one or more configurable components of the plurality of configurable components, wherein the shared framework layer is configured to fetch the shared data objects to enable execution of the at least one application service, wherein fetching of the shared data objects is enabled via the foundation layer communicating with the shared framework layer, wherein the foundation layer is configured for infrastructure development through the one or more configurable components of the plurality of configurable components, manage database native queries mapped to that at least one operation using a data layer to communicate with the foundation layer through one or more configurable components of the plurality of configurable components, wherein the data layer is configured to manage database native queries mapped to the at least one operation; and execute the at least one operation and develop the one or more application using the application orchestrator to enable interaction of the plurality of configurable components in the layered architecture.

In an advantageous aspect, the codeless development platform architecture is a layered architecture structured to execute a plurality of complex enterprise application operations in an organized and less time-consuming manner due to faster processing as the underlining architecture is appropriately defined to execute the operations through shortest path. Further, the platform architecture enables secured data flow through applications and resolution of code break issues without affecting neighboring functions or application. Moreover, the large language model's (LLM) accuracy of processing any input to execute a task is dependent on the efficiency of processing real time datasets generated due to the codeless platform architecture. The LLM agent is configured to process inputs by considering the real time datasets generated in one or more application developed by codeless platform. The technical problem in accurately identifying varied intents for executing a task related to procurement, supply chain, application integration, application restructuring or application development is addressed through learning and processing by large language models.

In another advantageous aspect, the present invention utilizes Machine Learning algorithms, large language models, artificial intelligence-based process orchestration for data processing to identify user intent in varied scenarios for executing the required task.

### BRIEF DESCRIPTION OF THE DRAWINGS

The disclosure will be better understood when consideration is given to the drawings and the detailed description which follows. Such description makes reference to the annexed drawings wherein:

FIG. 1 is an architecture diagram of a large language model-based data processing system configured for one or more applications developed by a codeless platform in accordance with an embodiment of the invention.

FIG. 2 a flow diagram of a large language model (LLM) based data processing method is provided in accordance with an embodiment of the invention.

FIG. 3 is a block diagram depicting a bot builder flow for the data processing system in accordance with an embodiment of the invention.

FIG. 4 is a block diagram depicting a bot builder training flow for the data processing system in accordance with an embodiment of the invention.

FIG. 5 shows a block diagram depicting a bot builder inference flow for the data processing system in accordance with an example embodiment of the invention.

FIG. 6 shows deep learning based large language model architecture with encoder and decoder in accordance with an example embodiment of the invention.

FIG. 6A shows neural network of the data processing system in accordance with an example embodiment of the invention.

FIG. 7 shows a block diagram depicting a conversational assistant driven autonomous procurement system in accordance with an embodiment of the invention.

FIG. 8, shows an electronic user interface screen of the data processing system having a chatbot for conversation orchestration to execute contract creation task in accordance with an example embodiment of the invention.

FIG. 8A, shows an electronic user interface screen of the data processing system having a chatbot for conversation orchestration to execute contract creation task showing one or more templates in accordance with an example embodiment of the invention.

FIG. 8B, shows an electronic user interface screen of the data processing system with contract template and recommended clauses in accordance with an example embodiment of the invention.

FIG. 8C, shows a user interface of a contract module persona of the data processing system in accordance with an example embodiment of the invention.

FIG. 9 shows a user interface of a real time shipment tracking and multi-model shipment tracking in accordance with an example embodiment of the invention.

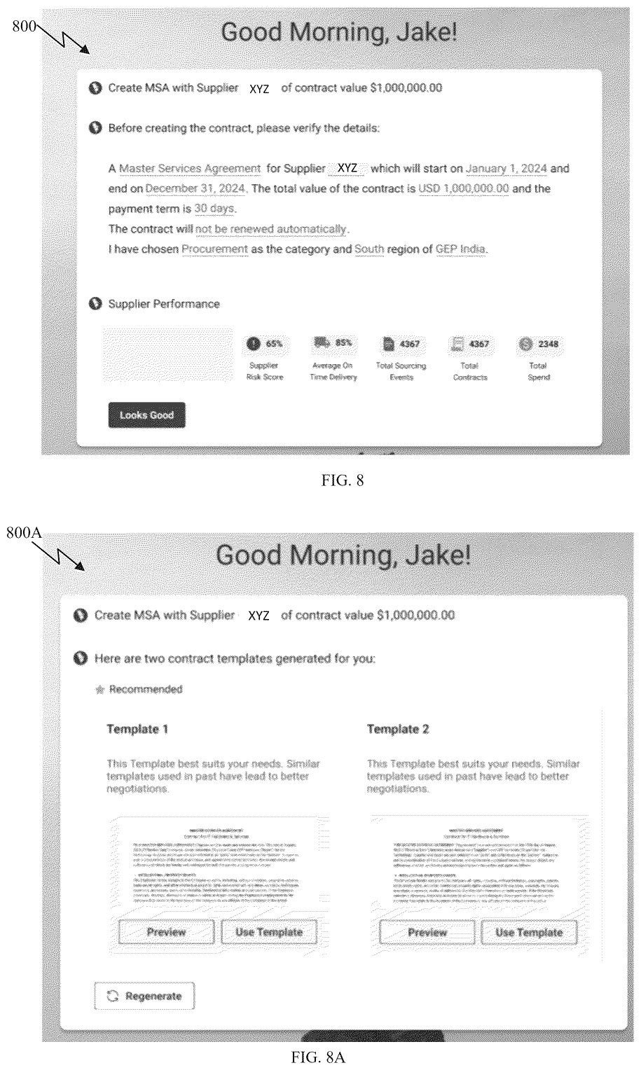

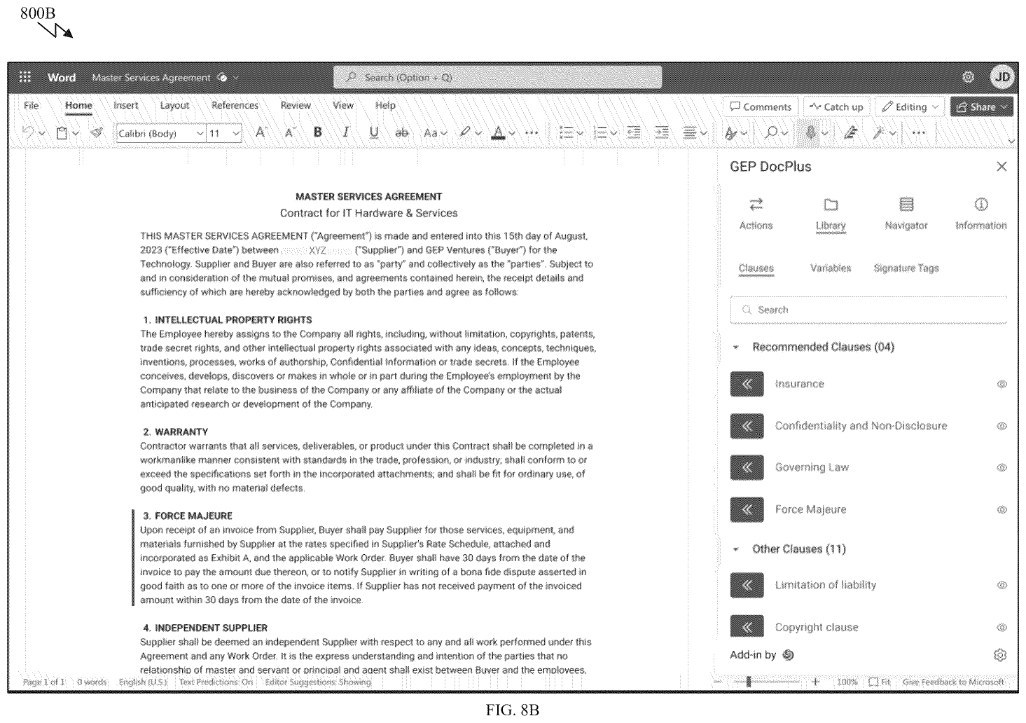

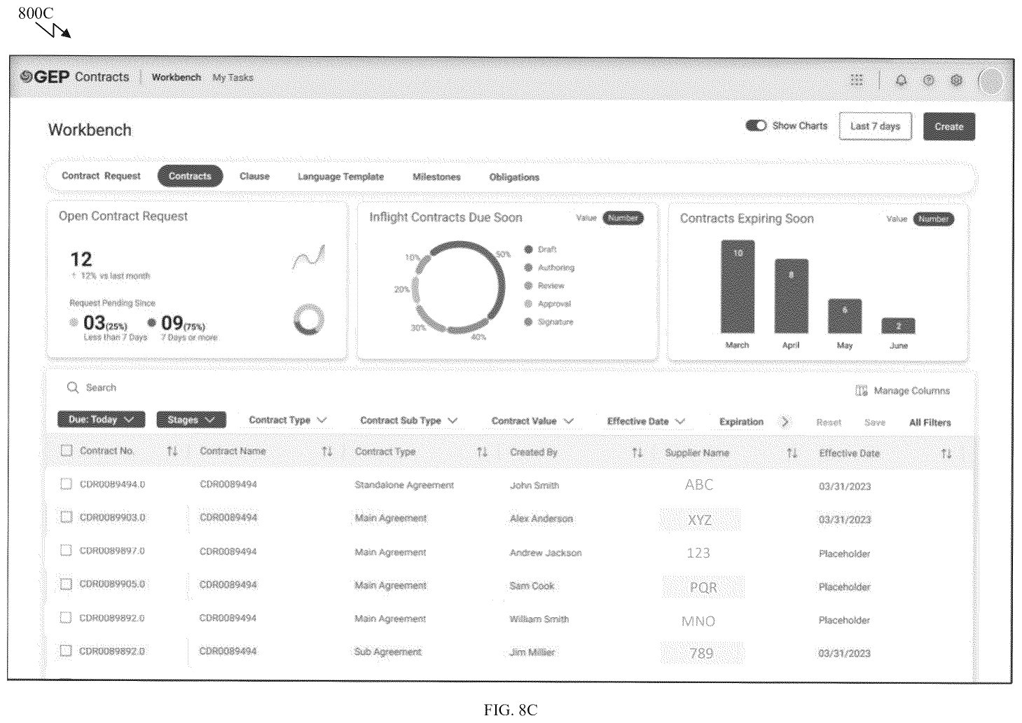

FIG. 8A shows user input with a natural language command of the data processing system in accordance with an example embodiment of the invention.

FIG. 8B shows a response of the data processing system to the user input in accordance with an embodiment of the invention.

FIG. 8C shows a training data format of the data processing system in accordance with an example embodiment of the invention.

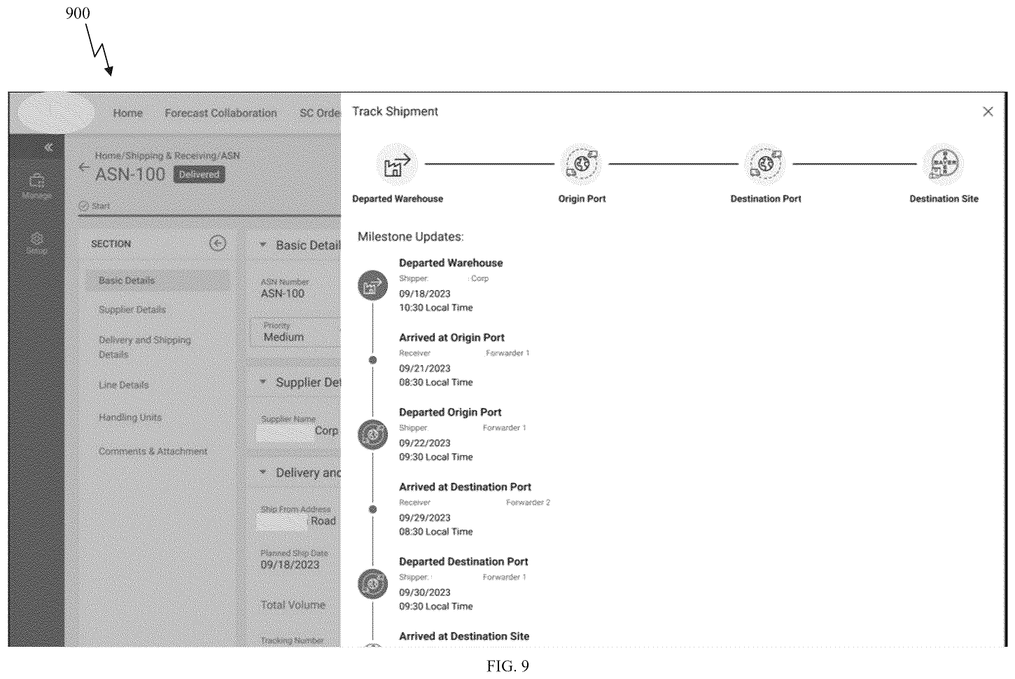

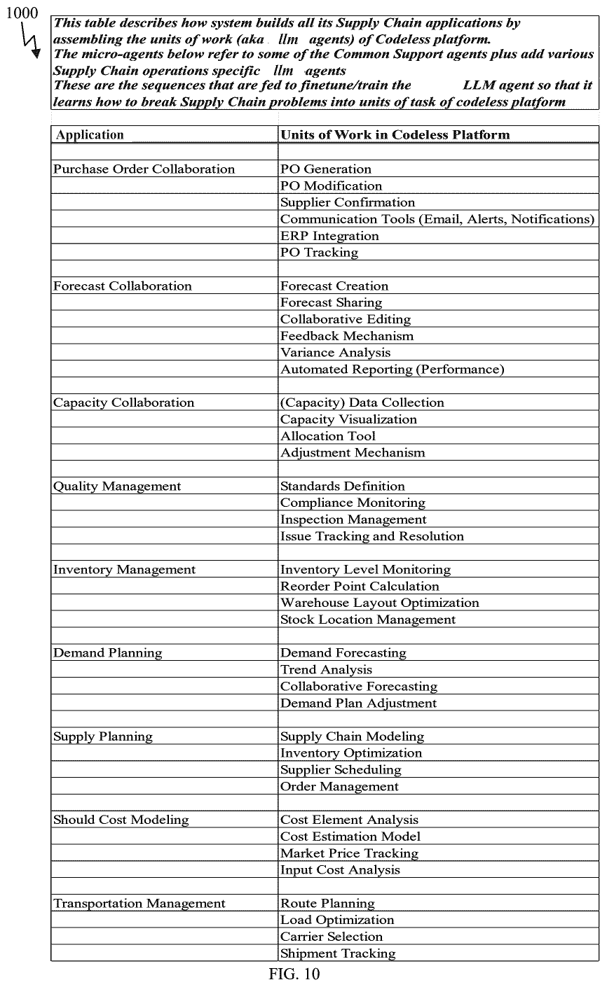

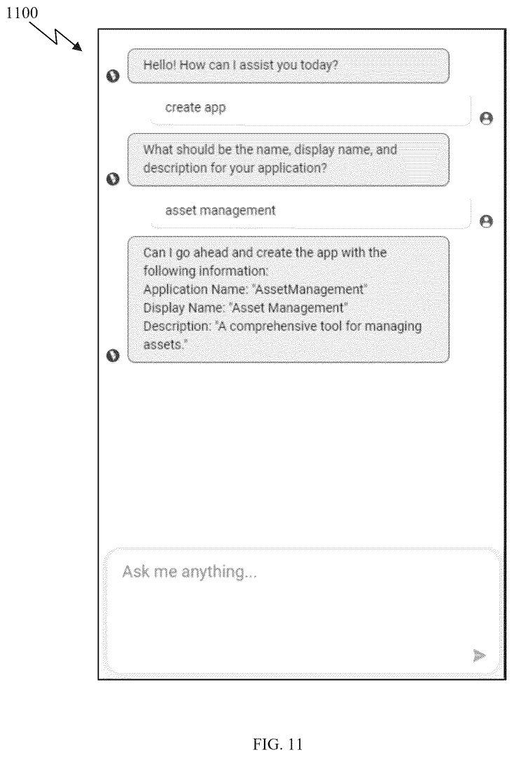

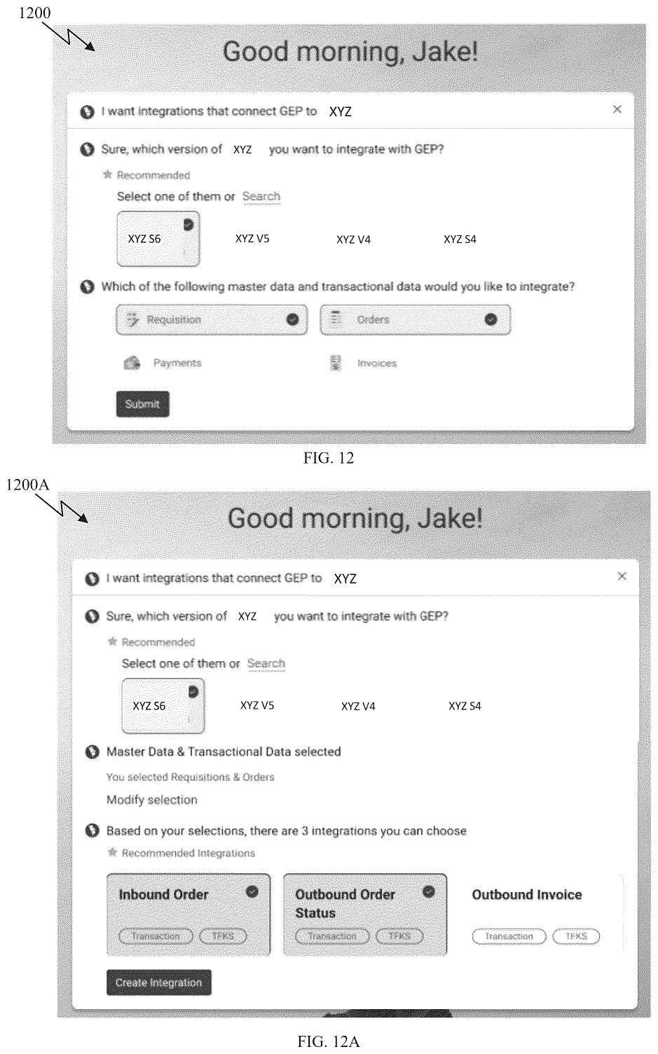

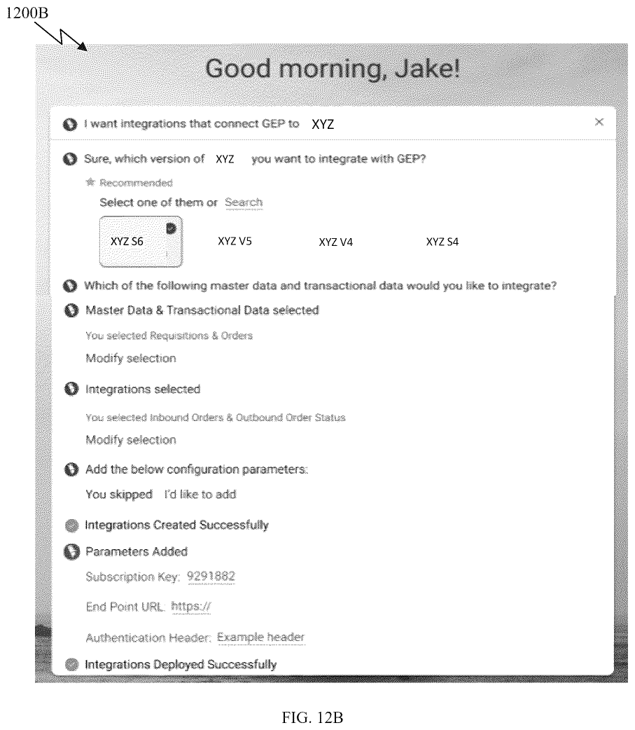

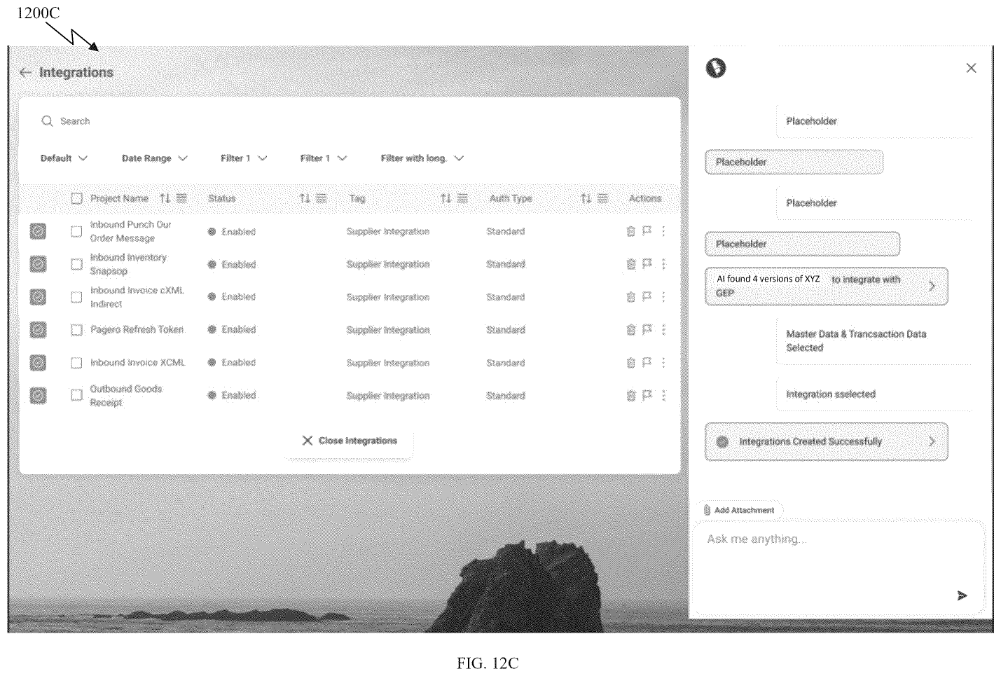

FIG. 9 shows an electronic user interface of the data processing system having a chatbot for conversation orchestration to execute contract creation task in accordance with an example embodiment of the invention.

FIG. 10 shows a table of how the data processing system creates a Supply Chain application by assembling the units of work of Codeless platform in accordance with an example embodiment of the invention.

FIG. 11 shows a graphical user interface (GUI) with a conversational assistant for application development or restructuring in accordance with an embodiment of the invention.

FIG. 12 shows a user interface with a conversational assistant configured for executing application integration tasks in accordance with an embodiment of the invention.

FIG. 12A shows a user interface with options of integrating one application to another enterprise application in accordance with an embodiment of the invention.

FIG. 12B shows a user interface with deployment of integration of one application with another ERP application in accordance with an example embodiment of the invention.

FIG. 12C shows a user interface depicting supplier integration of master data and transaction data of one application with another enterprise application in accordance with an example embodiment of the invention.

### DETAILED DESCRIPTION

Described herein are the various embodiments of the present invention, which includes large language model-based data processing system and method for one or more application developed by a codeless platform.

The various embodiments including the example embodiments will now be described more fully with reference to the accompanying drawings, in which the various embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, the sizes of components may be exaggerated for clarity.

It will be understood that when an element or layer is referred to as being “on,” “connected to,” or “coupled to” another element or layer, it can be directly on, connected to, or coupled to the other element or layer or intervening elements or layers that may be present. As used herein, the term “and/or” includes any and all combinations of one or more of the associated listed items.

Spatially relative terms, such as “Large language model (LLM),” “machine learning (ML)”, or “Large graph model (LGM),” and the like, may be used herein for ease of description to describe one element or feature's relationship to another element(s) or feature(s) as illustrated in the figures. It will be understood that the spatially relative terms are intended to encompass different orientations of the structure in use or operation in addition to the orientation depicted in the figures.

The subject matter of various embodiments, as disclosed herein, is described with specificity to meet statutory requirements. However, the description itself is not intended to limit the scope of this patent. Rather, the inventors have contemplated that the claimed subject matter might also be embodied in other ways, to include different features or combinations of features similar to the ones described in this document, in conjunction with other technologies. Generally, the various embodiments including the example embodiments relate to a large language model-based data processing system and method of procurement and supply chain application developed by codeless platform.

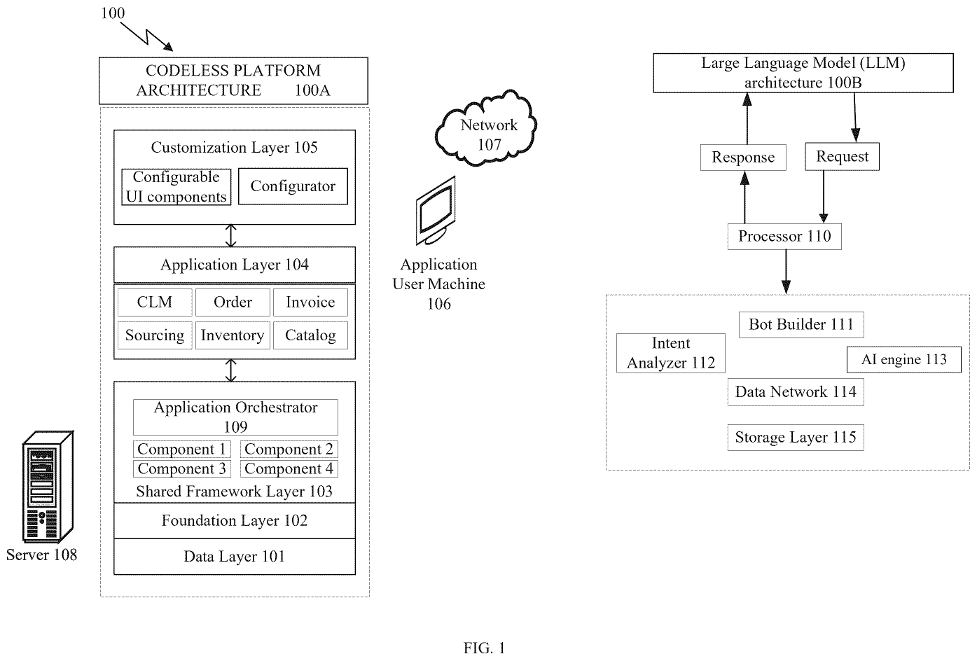

Referring to FIG. 1, an architecture diagram of a large language model-based data processing system 100 in a procurement and supply chain application developed by a codeless platform is provided in accordance with an embodiment of the present invention. The architecture of the data processing system includes a codeless platform architecture 100A and a large language model architecture 100B.

The codeless platform architecture 100A of the system 100 is a layered architecture 100A configured to process complex operations of one or more applications including supply chain management (SCM) applications using configurable components of each layer of the architecture 100A. The layered architecture enables faster processing of complex operations as the workflow may be reorganized dynamically using the configurable components. The layered architecture includes a data layer 101, a foundation layer 102, a shared framework layer 103, an application layer 104 and a customization layer 105. Each layer of the codeless platform architecture 100A includes a plurality of configurable components interacting with each other to execute at least one operation of the SCM enterprise application. It shall be apparent to a person skilled in the art that while FIG. 1 provide essential configurable components, the nature of the components itself enables redesigning of the platform architecture through addition, deletion, modification of the configurable components and their positioning in the layered architecture. Such addition, modification of configurable components depending on the nature of the architecture layer function shall be within the scope of this invention.

In an exemplary embodiment, the configurable components enable an application developer user/citizen developer, a platform developer user and a SCM application user working with the SCM application to execute the operations to code the elements of the SCM application through configurable components. The SCM application user or end user triggers and interacts with the customization layer 105 for execution of the operation through application user machine 106, a function developer user or citizen developer user triggers and interacts with the application layer 104 to develop the SCM application for execution of the operation through citizen developer machine, and a platform developer user through its computing device triggers the shared framework layer 103, the foundation layer 102 and the data layer 101 to structure the platform for enabling codeless development of SCM applications.

In an embodiment the present invention provides one or more SCM enterprise application with an end user application UI and a citizen developer user application UI for structuring the interface to carry out the required operations. Further, the layered platform architecture reduces complexity as the layers are built one upon another thereby providing high levels of abstraction, making it extremely easy to build complex features for the SCM application. However, one or more applications developed through the platform architecture requires reconfiguration of task management in the application. Since the functions are added or removed or modified by the developer seamlessly, the reconfiguration of the system to manage the related changes in the task is cumbersome.

In one embodiment, the codeless platform architecture 100A provides the cloud agnostic data layer 101 as a bottom layer of the architecture. This layer provides a set of microservices that collectively enable discovery, lookup and matching of storage capabilities to needs for execution of operational requirement. The layer enables routing of requests to the appropriate storage adaptation, translation of any requests to a format understandable to the underlying storage engine (relational, key-value, document, graph, etc.). Further, the layer manages connection pooling and communication with the underlying storage provider and automatically scales and de-scaling the underlying storage infrastructure to support operational growth demands.

In an example embodiment, a document data stores data abstraction of the data layer store all attributes of a document as a single record, much like a relational database system. The data is usually denormalized in these document stores, making data joins common in traditional relational systems unnecessary. Data joins (or even complex queries) can be expensive with this data store, as they typically require map/reduce operations which don't lend themselves well in transactional systems (OLTP-online transactional processing).

In another example embodiment, a relational data abstraction of the data layer allows for data to be sliced and analyzed in an extremely flexible manner.

In a related embodiment, the plurality of configurable components includes one or more data layer configurable components including but not limited to Query builder, graph database parser, data service connector, transaction handler, document structure parser, event store parser and tenant access manager. The data layer provides abstracted layers to the SCM service to perform data operations like Query, insert, update, delete and Join on various types of data stores document database (DB) structure, relational structure, key value structure and hierarchical structure.

In an embodiment the platform architecture provides the foundation layer 102 on top of the data layer 101 of the architecture 100. This layer provides a set of microservices that execute the tasks of managing code deployment, supporting code versioning, deployment (gradual roll out of new code) etc. The layer collectively enables creation and management of smart forms (and templates), framework to define UI screens, controls etc. through use of templates. Seamless theming support is built to enable specific form instances (created at runtime) to have personalized themes, extensive customization of the user experience (UX) for each client entity and or document. The layer enables creation, storage and management of code plug-ins (along with versioning support). The layer includes microservice and libraries that enable traffic management of transactional document data (by client entity, by document, by template, etc.) to the data layer 101, enables logging and deep call-trace instrumentation, support for request throttling, circuit breaker retry support and similar functions. Another set of microservice enables service to service API authentication support, so API calls are always secured. The foundation layer micro services enable provisioning (on boarding new client entity and documents), deployment and scaling of necessary infrastructure to support multi-tenant use of the platform. The set of microservices of foundation layer are the only way any higher layer microservice can talk to the data layer microservices. Further, machine learning techniques auto-scale the platforms to optimize costs and recommend deployment options for entity such as switching to other cloud vendors etc.

In an exemplary embodiment, the data layer 101 and foundation layer 102 of the architecture 100 function independent of the knowledge of the operation. Since, the platform architecture builds certain configurable component as independent of the operation in the application, they are easily modifiable and restructured.

In a related embodiment, the plurality of configurable components includes one or more foundation layer configurable components including but not limited to logger, Exception Manager, Configurator Caching, Communication Layer, Event Broker, Infra configuration, Email Sender, SMS Notification, Push notification, Authentication component, Office document Manager, Image Processing Manager, PDF Processing Manager, UI Routing, UI Channel Service, UI Plugin injector, Timer Service, Event handler, and Compare service for managing infrastructure and libraries to connect with cloud computing service.

In an embodiment, the platform architecture provides the shared framework layer 103 on top of the foundation layer 102. This layer provides a set of microservices that collectively enable authentication (identity verification) and authorization (permissioning) services. The layer supports cross-document and common functions such as rule engine, workflow management, document approval (built likely on top of the workflow management service), queue management, notification management, one-to-many and many-to-one cross-document creation/management, etc. The layer enables creation and management of schemas (aka documents), and support orchestration services to provide distributed transaction management (across documents). The service orchestration understands different document types, hierarchy and chaining of the documents etc.

The shared framework layer 103 has the notion of our operational or application domains, the set of microservices that contribute this layer hosts all the common functionality so individual documents (implemented at the application layer 104) do not have to repeatedly to the same work. In addition to avoiding the reinventing the wheel separately by each developer team, this layer of microservices standardizes the capabilities so there is no loss of features at the document level, be it adding an attribute (that applies to a set of documents), supporting complex approval workflows, etc. The rule engine along with tools to manage rules is part of this layer.

In a related embodiment, the plurality of configurable components includes one or more shared framework configurable components including but not limited to license manager, Esign service, application marketplace service, Item Master Data Component, organization and accounting structure data component, master data, Import and Export component, Tree Component, Rule Engine, Workflow Engine, Expression Engine, Notification, Scheduler, Event Manager, and version service.

In one embodiment, architecture 100 provides the application layer 104 on top of the shared framework layer 103 of the architecture. The developer user of the platform will interact with application layer 103 for structuring the SCM application. This is also the first layer that defines SCM specific documents such as requisitions, contracts, orders, invoices etc. This layer provides a set of microservices to support creation of documents (requisition, order, invoice, etc.), support the interaction of the documents with other documents (ex: invoice matching, budget amortization, etc.) and provide differentiated operational/functional value for the documents in comparison to a competition by using artificial intelligence and machine learning. This layer also enables execution of complex operational/functional use cases involving the documents.

In an exemplary embodiment, a developer user or admin user will structure one or more SCM application and associated functionality by the application layer of microservices, either by leveraging the shared frameworks platform layer or through code to enable the notion of specific documents or through building complex functionality by intermingling shared frameworks platform capabilities with custom code. Besides passing on the entity metadata to the shared frameworks layer, this set of microservices do not carry any concern about where or how data is stored. Data modeling is done through template definitions and API calls to the shared frameworks platform layer. This enables this layer to primarily and solely focus on adding operational/functional value without worrying about infrastructure.

Further, in an advantageous aspect, all functionality or application services built at the application layer are exposed through an object model, so higher levels of application orchestrations of all these functionalities is possible to build by custom implementations for end users. The platform will stay pristine and clean and be generic, while at the same time, enables truly custom features to be built in a lightweight and agile manner. The system of the invention is configured to adapt to the changes in the application due to the custom features and operate the application to manage one or more tasks to be executed.

In an embodiment, architecture 100 provides the customization layer 105 as the topmost layer of the architecture above the application layer 104. This layer provides microservices enabling end users to write codes to customize the operational flows as well as the end user application UI to execute the operations of SCM. The end user can orchestrate the objects exposed by the application layer 104 to build custom functionality, to enable nuanced and complex workflows that are specific to the end user operational requirement or a third-party implementation user.

In a related embodiment, the plurality of configurable components includes one or more customization layer configurable components including but not limited to a plurality of rule engine components, configurable logic component, component for structuring SCM application UI, Layout Manager, Form Generator, Expression Builder Component, Field & Metadata Manager, store-manager, Internationalization Component, Theme Selector Component, Notification Component, Workflow Configurator, Custom Field Component & Manager, Dashboard Manager, Code Generator and Extender, Notification, Scheduler, form Template manager, State and Action configurator for structuring the one or more SCM application to execute at least one SCM application operation.

In an exemplary embodiment, each of these layers of the platform architecture communicates or interacts only to the layer directly below and never bypasses the layers through operational workflow thereby enabling highly productive execution with secured interaction through the architecture.

Depending on the type of user the user interface (UI) of the application user machine 106 is structured by the platform architecture. The application user machine 106 with a application user UI is configured for sending, receiving, modifying or triggering processes and data object for operating one or more of a SCM application over a network 107.

The computing devices referred to as the entity machine, server, processor etc. of the present invention are intended to represent various forms of digital computers, such as laptops, desktops, workstations, personal digital assistants, and other appropriate computers. Computing devices of the present invention further intend to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this disclosure.

The system includes a server 108 configured to receive data and instructions from the application user machines 106. The system 100 includes a support mechanism for performing various prediction through AI engine and mitigation processes with multiple functions including historical dataset extraction, classification of historical datasets, artificial intelligence-based processing of new datasets and structuring of data attributes for analysis of data, creation of one or more data models configured to process different parameters.

In an embodiment, the system is provided in a cloud or cloud-based computing environment. The codeless development system enables more secured processes.

In an embodiment the server 108 of the invention may include various sub-servers for communicating and processing data across the network. The sub-servers include but are not limited to content management server, application server, directory server, database server, mobile information server and real-time communication server.

In example embodiment the server 108 shall include electronic circuitry for enabling execution of various steps by server processor. The electronic circuitry has various elements including but not limited to a plurality of arithmetic logic units (ALU) and floating-point Units (FPU's). The ALU enables processing of binary integers to assist in formation of at least one table of data attributes where the data models implemented for dataset characteristic prediction are applied to the data table for obtaining prediction data and recommending action for codeless development of SCM applications. In an example embodiment the server electronic circuitry includes at least one Athematic logic unit (ALU), floating point units (FPU), other processors, memory, storage devices, high-speed interfaces connected through buses for connecting to memory and high-speed expansion ports, and a low-speed interface connecting to low-speed bus and storage device. Each of the components of the electronic circuitry, are interconnected using various busses, and may be mounted on a common motherboard or in other manners as appropriate. The processor can process instructions for execution within the server 108, including instructions stored in the memory or on the storage devices to display graphical information for a graphical user interface (GUI) on an external input/output device, such as display coupled to high-speed interface. In other implementations, multiple processors and/or multiple busses may be used, as appropriate, along with multiple memories and types of memory. Also, multiple servers may be connected, with each server providing portions of the necessary operations (e.g., as a server bank, a group of blade servers, or a multi-processor system).

In an example embodiment, the system of the present invention includes a front-end web server communicatively coupled to at least one database server, where the front-end web server is configured to process data based on large language models and applying an AI based dynamic processing logic to automate prioritization of task in the application developed by the codeless development actions through orchestrator.

In an embodiment, the platform architecture 100 of the invention includes an application orchestrator 109 configured for enabling interaction of the plurality of configurable components in the layered architecture 100 for executing at least one SCM application operation and development of the one or more SCM application based on one or more LLM agent. The application orchestrator 109 includes plurality of components including an application programming interface (API) for providing access to configuration and workflow operations of SCM application operations, an Orchestrator manager configured for Orchestration and control of SCM application operations, an orchestrator UI/cockpit for monitoring and providing visibility across transactions in SCM operations and an AI based application orchestration engine configured for interacting with a plurality of configurable components in the platform architecture for executing SCM operations.

In an embodiment, the application orchestrator includes a blockchain connector for integrating blockchain services with the one or more SCM application and interaction with one or more configurable components. Further, Configurator User interface (UI) services are used to include third party networks managed by domain providers.

In a related aspect, the Artificial intelligence (AI) based orchestrator engine enables execution of SCM operation by at least one data model wherein the AI engine transfers processed data to the User Interface (UI) for visibility, exposes SCM operations through API and assist the manager for application orchestration and control.

In an exemplary embodiment, the AI engine employs machine learning techniques that learn patterns and generate insights from the data for enabling the application orchestrator to automate operations. Further, the AI engine with ML employs deep learning that utilizes artificial neural networks to mimic biological neural networks in human brains. The artificial neural networks analyze data to determine associations and provide meaning to unidentified or new dataset.

In another embodiment, the invention enables integration of Application Programming Interfaces (APIs) for plugging aspects of AI into the dataset characteristic prediction and operations execution for operating one or more SCM enterprise application.

In an embodiment, the system 100 of the present invention includes a workflow engine that enables monitoring of workflow across the SCM applications. The workflow engine with the application orchestrator enables the platform architecture to create multiple approval workflows. The task assigned to a user is prioritized through the AI based data processing system based on real time information.

In an embodiment the machine 106 may communicate with the server 108 wirelessly through communication interface, which may include digital signal processing circuitry. Also, the machine (106) may be implemented in a number of different forms, for example, as a smartphone, computer, personal digital assistant, or other similar devices.

In an embodiment, the large language model architecture 100B includes a processor 110 configured for receiving the input from a user through the electronic user interface and generating a response on an electronic user interface. Processor 106 serves as the bridge between the user and the backend components of the LLM architecture. The LLM architecture 100B includes an intent analyzer 111 configured to analyze intent of the input received at through a conversation assistant of an application. Architecture 100B, further includes a bot builder 112 configured to build a cartridge of intents through which the intent analyzers identified the intent of the received input. Architecture 100B also includes an AI engine 113 configured to process a plurality of historical application data and user activity data from a data lake. The architecture 100B further includes a data network 114 configured for storing and processing of one or more dataset of the one or more application developed by the codeless platform, wherein a data network server is configured to receive the one or more dataset from a plurality of data source for structuring a multi-tier multi-party enabled data network 114.

In an exemplary embodiment, the architecture 100B may include a plurality of functional means configured for executing specific tasks related to one or more application developed by the codeless platform. The functional means include custom, curated and domain specific means including API (application programming interface) calls etc.

The processor 111 may be implemented as a chipset of chips that include separate and multiple analog and digital processors. The processor may provide coordination of the other components, such as controlling user interfaces, applications run by devices, and wireless communication by devices. The Processor may communicate with a user through control interface and display interface coupled to a display. The display may be, for example, a TFT LCD (Thin-Film-Transistor Liquid Crystal Display) or an OLED (Organic Light Emitting Diode) display, or other appropriate display technology. The display interface may comprise appropriate circuitry for driving the display to present graphical and other information to an entity/user. The control interface may receive commands from a user/demand planner and convert them for submission to the processor. In addition, an external interface may be provided in communication with processor, so as to enable near area communication of device with other devices. External interface may provide, for example, for wired communication in some implementations, or for wireless communication in other implementations, and multiple interfaces may also be used.

In a related embodiment, the LLM architecture 100B includes a custom fine-tuned agent configured for selecting and changing a required set of means to execute a user specific task. This agent is supported by a finetuned LLM calibrated for tool selections and function execution tasks. The system includes a set of API executors of all major API's form part of the toolbox. Further, the tools also include databases and data source connector tools. The tool includes large language model (LLM) with access to a bundle of tools to achieve pre-defined objectives. These agents are driven by prompt(s) configured to enable process orchestration and tool selection.

In an embodiment, the LLM architecture 110B includes a storage layer 115 configured to keep track of all the required data or information generated during data processing. This component of the LLM architecture 110B is configured for storing information such as memory objects, the selected tools, the state of execution and the error messages among others.

In an exemplary embodiment, the memory or storage layer may be a volatile, a non-volatile memory or memory may also be another form of computer-readable medium, such as a magnetic or optical disk. The memory store may also include storage device capable of providing mass storage. In one implementation, the storage device may be or contain a computer-readable medium, such as a floppy disk device, a hard disk device, an optical disk device, or a tape device, a flash memory or other similar solid-state memory device or an array of devices, including devices in a storage area network or other configurations.

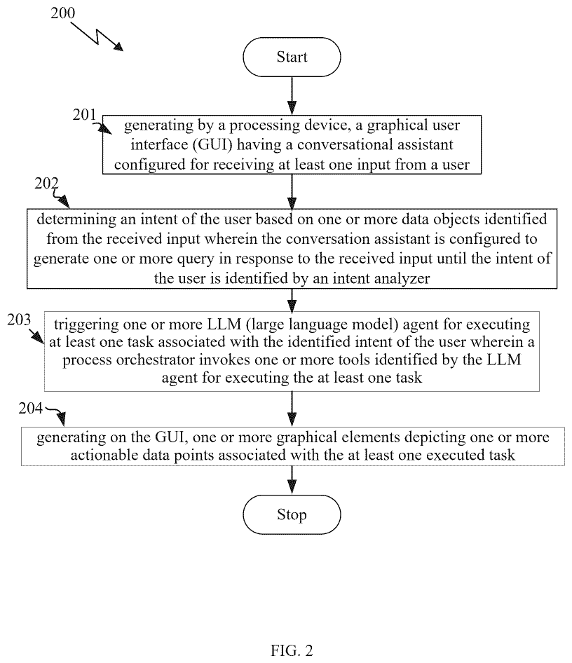

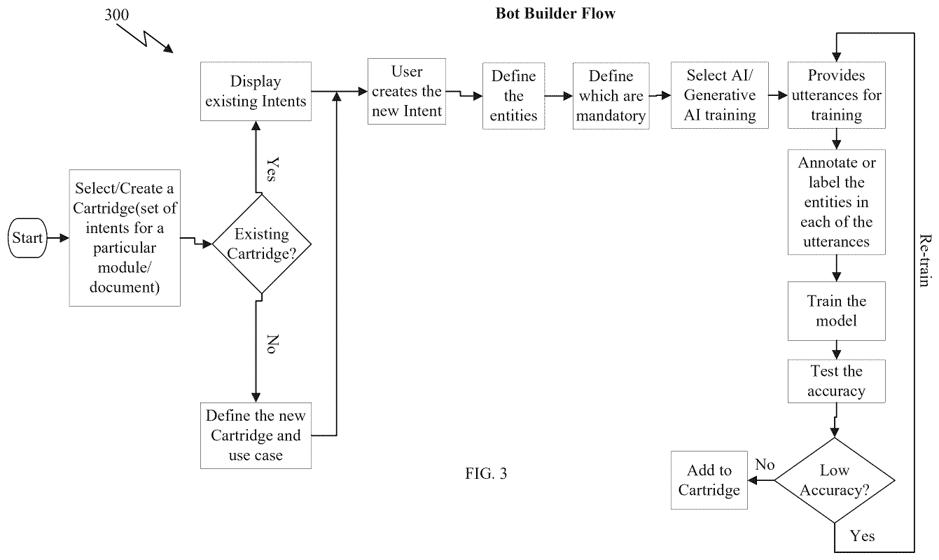

Referring to FIG. 2, a flow diagram 200 of a large language model (LLM) based data processing method is provided in accordance with an embodiment of the invention. The method includes the step 201 generating by a processing device, a graphical user interface (GUI) having a conversational assistant configured for receiving at least one input from a user. The method includes step 202 of determining an intent of the user based on one or more data objects identified from the received input wherein the conversation assistant is configured to generate one or more query in response to the received input until the intent of the user is identified by an intent analyzer. The data processing method also includes the step 203 of triggering one or more LLM (large language model) agent for executing at least one task associated with the identified intent of the user wherein a process orchestrator invokes one or more tools identified by the LLM agent for executing the at least one task and in step 204, generating on the GUI, one or more graphical elements depicting one or more actionable data points associated with the at least one executed task.

In a related embodiment, the conversational assistant is configured to enable execution of data operations, such as denormalization, aggregation, filtering, sorting, and grouping, creation of custom AI models, such as regression, classification, clustering, and anomaly detection, and generation of insights and predictions from the data.

Referring to FIG. 3, a bot builder flow diagram 300 depicting flow of the bot builder is provided in accordance with an embodiment of the invention. The flow diagram for building the bot includes selecting/creating at least one cartridge having a set of intents for a particular module/document. Based on the received input, identifying if the cartridge is existing, if no, then defining the new cartridge else, displaying existing set of intents from the identified cartridge. For the bot builder, the user creates the new intent, the entities are defined, defining mandatory and AI/Generative AI training is selected. Depending on the accuracy of the intent, it is added to the cartridge or retrained based on the generative AI training models.

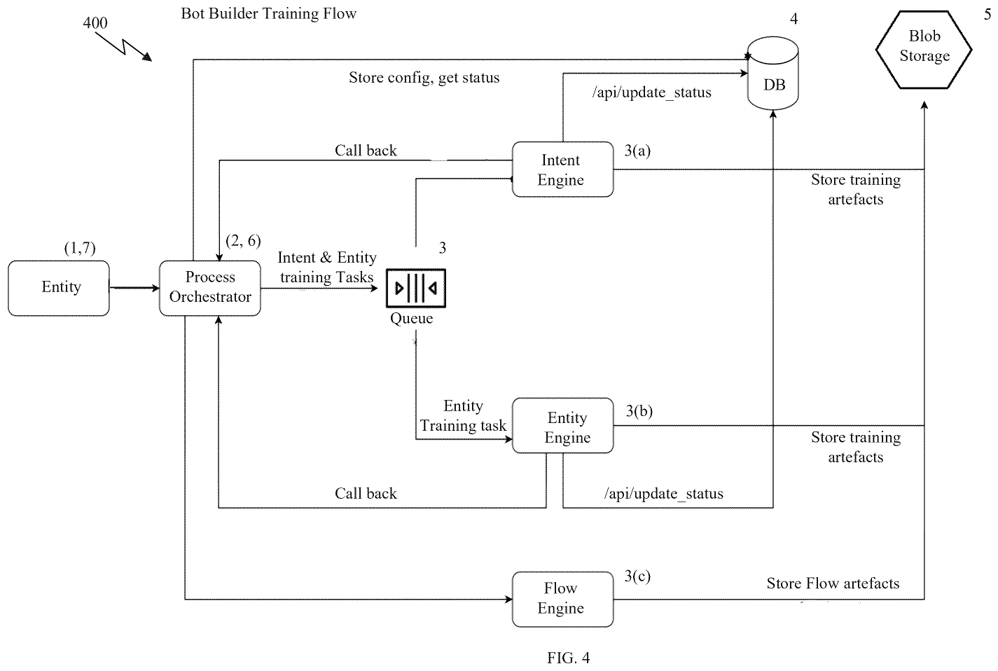

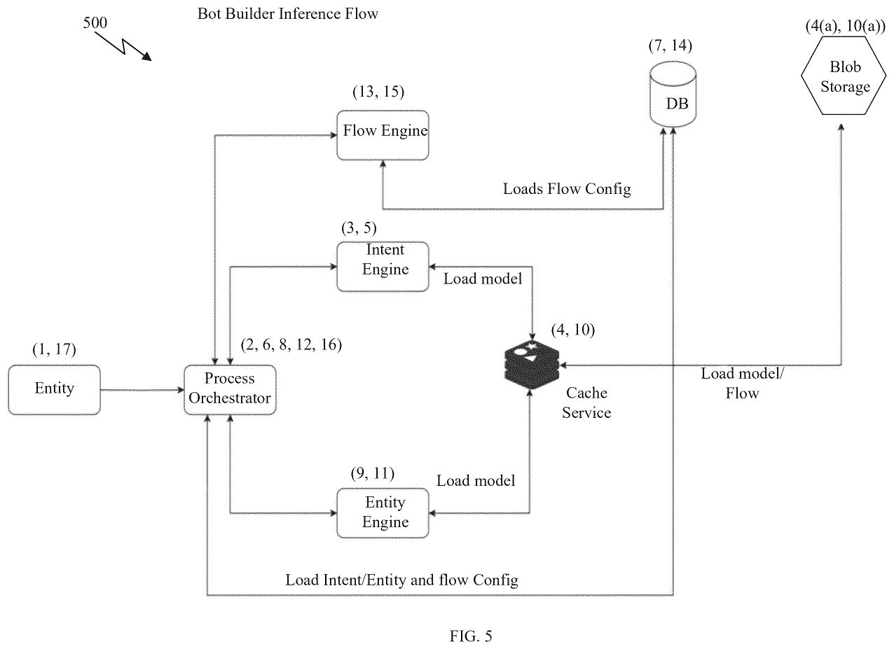

Referring to FIG. 4, a bot builder training flow diagram 400 is provided in accordance with an embodiment of the invention. The training flow diagram 400 includes receiving at process orchestrator, an input from a client/entity. The bot builder is configured to process one or more historical data for generating and storing, training artifacts and flow artifacts in an intent database. The intent analyzer processes the received input based on one or more intent data models to identify the intent. The bot builder training includes an intent engine, an entity training engine, and a flow engine for storing training and flow artifacts.

In a related embodiment, the intent analyzer is configured to analyze the intent from the received input by converting the received input into numerical representation through embeddings, creating embeddings, one or more clusters during training and receiving sample prompts from users wherein each cluster represents a different intent, and identifying cluster nearest to an embedding representation of the received input to determine the intent, wherein a generative AI based reasoning model enables mapping of the received input to the intent in case the embedding representation is equally close to different clusters.

In a related embodiment, a bot builder inference flow diagram 500 is provided. The inference flow diagram 500 includes loading intent/entity and flow configuration in database, loading model/flow in blob storage.

Once the input is received by the data processing system, a task specific prompt is generated to trigger one or more LLM agent. Each of the one or more LLM is trained on a historical dataset associated with at least one application of the one or more application developed by the codeless platform. Depending on the task to be executed, the system identifies and triggers the required tool for execution of the task. Since, the task is associated with a supply chain or procurement application, the identification of the intent associated with the application is critical and the one or more LLM which are trained with all sub-application datasets is configured to derive the relationship between multiple sub applications to trigger the relevant LLM.

In an embodiment, the at least one application includes a supply chain management application and the at least one task includes a supply chain management application task such as contract management, Purchase order, invoice management, Spend analysis, Sourcing, inventory management, demand planning, quality management, supply planning, should cost modeling, transportation management, warehouse management, forecasting, vendor management, risk assessment management and project management.

In an embodiment, the process orchestrator performs sequence management, execution state control and conversation state management.

In an embodiment, the LLM agent is configured to adapt to real time changing characteristics of the one or more application developed by the codeless platform and interact with the one or more LLM agent to execute the at least one task.

In an exemplary embodiment, the method of training one or more LLM agent and the master controller LLM agent includes the step of collecting, storing and pre-processing a plurality of historical data as a training data wherein the historical data is stored in a SCM historical database. The training includes the step of cleansing the training dataset by converting the historical data, removing unwanted text from the historical data and tokenizing the training dataset into sequences of tokens that form the training dataset. Further, the training method includes configuring a neural network based on the training dataset wherein the micro LLM agent is trained with supervised and unsupervised learning by presenting a sequence of text to the LLM agent for training the agent to predict next text in the sequence wherein the LLM agent adjusts its weight based on a difference between its prediction and actual text.

In a related embodiment, the method of training includes evaluating performance of the one or more LLM agent based on a testing dataset wherein the one or more LLM agent is finetuned by adjusting one or more hyperparameters, chaining model architecture or training the micro LLM agent on additional training dataset to improve performance.

In an exemplary embodiment, a method of fine tuning the one or more LLM agent includes the step of loading a plurality of historical dataset related to one or more application workflows of the codeless platform into a vector index to enable semantic search. The finetuning method includes the step of triggering one or more unit of task action descriptions index and a knowledge graph on units of task as additional tools for the one or more LLM agent. The finetuning method includes generating variations of the input requiring cross-referencing the unit of task action descriptions and knowledge graph including substituting steps within the workflow or augmenting the input with additional flows. The finetuning further includes running the input including the variations through a reference LLM, identifying one or more high reward input-output pair for fine tuning the LLM agents, and evaluating on a testing dataset, contextualization and substitution ability of the one or more LLM agents through the description index wherein a matrix is utilized on the testing dataset to assess the one or more LLM agents.

In an embodiment, the LLM agent is configured to be trained in a distributed structure with artificial intelligence controllers wherein different parts of the LLM agent are distributed across a plurality of Graphics processing units (GPU) for parallel training of the micro LLM agent. The GPUs (Graphical processing units) with LLM agents enable enhancement of computing power by processing humongous amounts of data.

In a related embodiment, the parallel training of the one or more LLM agent includes data parallelism, sequence parallelism, pipeline parallelism and tensor parallelism.

In an embodiment, the electronic user interface includes an input component configured to receive the input, wherein the input component is a chatbot configured to receive a text, image or voice input wherein the image or voice input is converted to text by one or more processors for enabling the LLM agent to identify the intent of the user and the at least one task to be executed.

In an exemplary embodiment, the data processing system of the invention includes a data network configured for storing and processing of one or more dataset of the one or more application developed by the codeless platform. The data network server is configured to receive one or more dataset from a plurality of data source for structuring a multi-tier multi-party enabled data network. The system includes one or more data element nodes configured to create one or more sub-network through a graphical data structure wherein one or more data elements are extracted from the one or more dataset for relationship analysis to identify the one or more data elements to be ingested as one or more data element node of the data network; and one or more data connectors of the graphical data structure configured for connecting the one or more data element node to form the data network.

In an embodiment, the data processing system of the invention includes one or more large graph models (LGM) configured to interact with the one or more LLM agent based on alignment of representation basis of graphs and text through paired data enabling interaction through natural language, or by transforming graph structures to text representations including adjacent list, edge list and inserting into LLM agents as prompts, or by aligning behavior of one or more graph models with one or more graph task scripts.

As the complexity of graph increases, the pre-training of large graph models (LGM) becomes more evident. Unlike pre-training methods for other types of data, such as languages and images, which focus primarily on semantic information, graphs contain rich structural information. Pre-training large graph models essentially needs to integrate structural and semantic information from diverse graph datasets. Pre-training on a wide range of graph datasets and tasks act as a regularizing mechanism, preventing the model from overfitting to a specific task and improving generalization performance. Further, by pre-training large graph models on diverse graph datasets, they are configured to capture a wide range of structural patterns, which are applied, adapted, or fine-tuned to graph data in similar domains, maximizing the model's utility.

Further, LLM and LGM required post processing to enhance their ability to downstream tasks. Some of the post-processing techniques include prompting, parameter-efficient fine-tuning, reinforcement learning with feedback, and model compression.

In an exemplary embodiment, the data network structured on relationships between documents or references to documents maintains the relationship across documents and navigates across documents in a blazingly fast manner. Nodes in the graph can be partitioned easily, making it conductive to building horizontally scalable systems, which in turn enables building of LGM models.

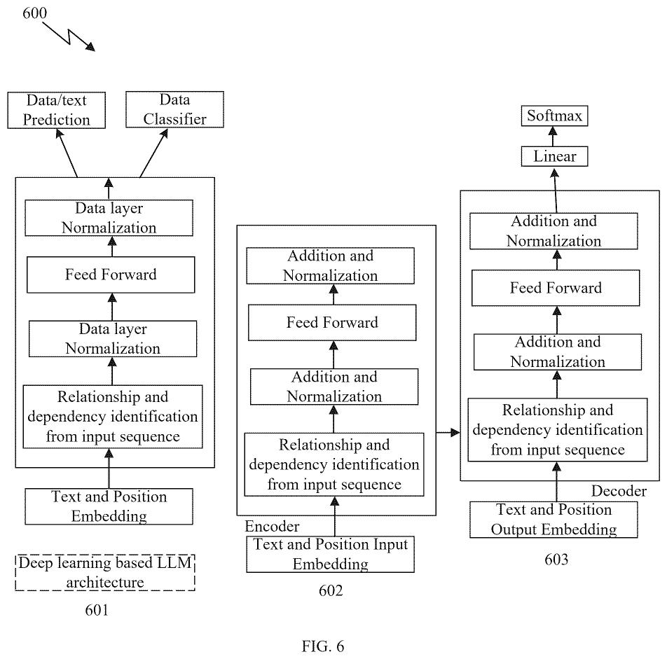

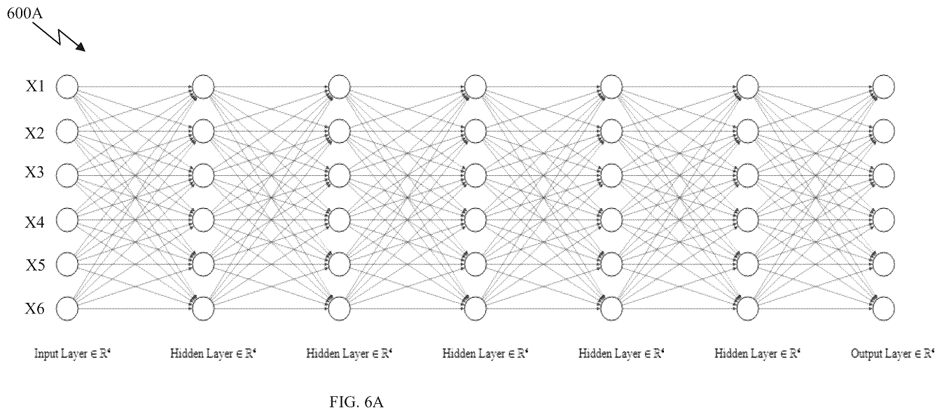

In an exemplary embodiment, the data processing system of the invention is configured for large-scale pre-training of models on supply chain and procurement domain data and adaptation to particular SCM tasks or sub domains. However, as larger models are pre-trained, full fine-tuning, which retrains all model parameters, becomes less feasible. In an advantageous aspect, Low-Rank Adaptation (LORA), is used which freezes the pre-trained model weights and injects trainable rank decomposition matrices into each layer of the deep learning based LLM architecture 600 as shown in FIG. 6. This greatly reduces the number of trainable parameters for downstream tasks. LORA significantly reduces the number of trainable parameters and the GPU memory requirements. LORA performs better despite having fewer trainable parameters, a higher training throughput, and, unlike adapters, no additional inference latency. Further, the data processing system facilitates integration of LORA with other models to provide efficient implementations and model checkpoints.

Referring to FIG. 6, a flow diagram 600 depicting a deep learning based large language model architecture 601 with encoder 602 and decoder 603 is provided in accordance with an example embodiment of the invention. To process a text input with a deep learning LLM, it is tokenized into a sequence of words. These tokens are then encoded as numbers and converted into embeddings, which are vector-space representations of the tokens that preserve their meaning. Next, the encoder in architecture transforms the embeddings of all the tokens into a context vector. The context vector allows the model to attend to different parts of an input sequence to capture its relationships and dependencies. Using the context vector, the architecture decoder generates output based on data objects of the input. For instance, the data object of the input provided by the user acts as an intent identifier and lets the decoder produce the subsequent word that naturally follows. Then, the data processing system reuses the same decoder, but at this instance the intent identifier is the previously produced next word. This process is repeated to create an entire paragraph, starting from a leading sentence. The context vector is large so it can handle very complex concepts, and with many layers in its encoder and decoder. The LLM based on deep learning captures long-range dependencies between words, graphs elements and hence the model understands the context. Also, LLM generates text based on previously generated tokens.

In a related aspect, for training the LLM, output of the context vector is fed into a feed-forward neural network, which performs a non-linear transformation to generate a new representation. To stabilize the training process, the output from each layer is normalized, and a residual connection is added to allow the input to be passed directly to the output, allowing the model to learn which parts of the input are most important.

Referring to FIG. 6A, a neural network 600A of the data processing system is provided in accordance with an example embodiment of the invention. The neural network 1000 are trained using self-supervised, semi-supervised or unsupervised learnings. This enables the LLM agent to identify the intent even from the unknown elements of the data objects in the input.

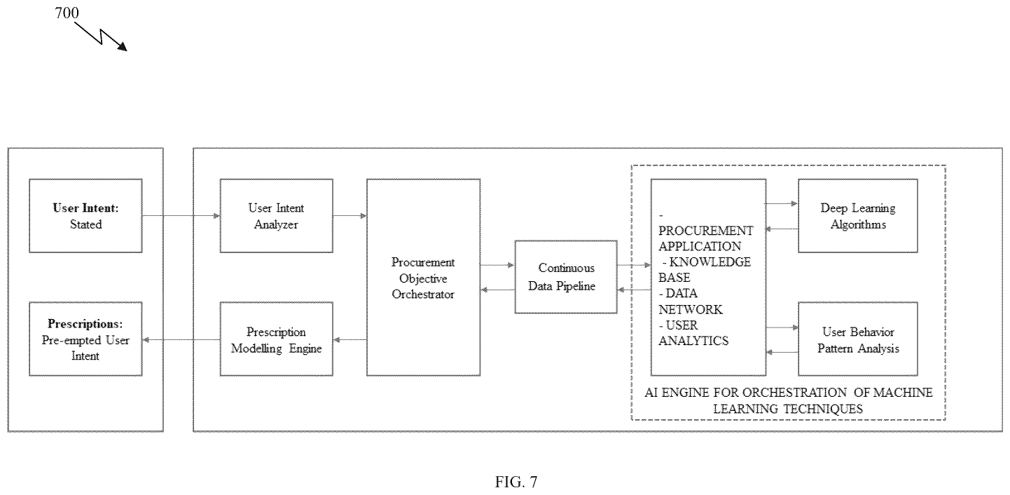

Referring to FIG. 7, a block diagram depicting a conversational assistant driven autonomous procurement system is shown in accordance with an example embodiment of the invention. The invention provides a conversational autonomous procurement system powered by Large Language Models (LLMs). The application leverages advanced NLP techniques and deep learning algorithms to understand user intent based on simple business commands, analyze requirements, automatically generate Requisitions & purchase orders, define procurement strategy, negotiate supplier prices, and manage the entire procurement cycle all through an intuitive and natural conversational interface. Some of the key components of the system include but are not limited to a) Large Language Models that include natural language processing models developed to understand and generate human-like text; b) Advanced NLP Techniques that enable the system to comprehend user intent accurately; c) User Intent Analyzer configured to identify procurement specific intent for navigating through procurement tasks. The system allows to define and manage library of intents, associate prompts with intents by using a machine learning framework that supports training language models and fine-tune the model using the labeled dataset, so it learns to associate specific language patterns with the defined intents. The system also self-enriches its knowledge based on user feedback once the end users start using the system. d) Application Orchestrator as procurement Objective Orchestrator is configured to analyze and comprehend procurement objectives outlined by stakeholders through simple conversations. The data processing includes breaking down complex procurement objectives received as the input into one or more actionable tasks through semantic analysis where, the one or more data models trained on procurement datasets enable analysis of real-time procurement data and trends to recommend strategy including corrections or adjustments to procurement strategy. e) Deep Learning Algorithms are leveraged to enhance the system's ability to analyze and interpret diverse procurement scenarios based on the GEP knowledge base of procurement practices. The Machine Learning based algorithms enable the system to learn and adapt to various user preferences and industry-specific procurement practices over time providing a more refined user experience with accurate intent detection and relevant recommendations; f) The Conversational Interface enables users to engage with a procurement system, facilitating the accomplishment of procurement tasks through a guided conversational approach. The application poses inquiries, assesses responses, and autonomously determines subsequent questions, offering suggestive answers to assist users in seamlessly completing procurement tasks through a succession of straightforward conversations; g) Data pipeline & aggregation techniques for managing data flow and aggregation methods specifically tailored for the integration of artificial intelligence features into procurement systems to achieve optimal performance; h) Prescription Modelling Engine where the system through user interactions within the application, establishes a network of potential user intents. Leveraging this network, the system discerns and prioritizes specific notifications to be generated for users. These notifications, functioning as pre-determined prompts, include comprehensive ready analyses aiding users in addressing high-priority tasks or potential risks that warrant mitigation.

In a related embodiment, the one or more procurement scenarios include spend analysis, sourcing, supplier management, opportunity identification, contract management, and negotiation as part of procurement operations.

In an exemplary embodiment, the data processing system and method facilitates robust spend analysis, empowering businesses to understand expenditure patterns, optimize costs, and improve overall financial efficiency through intuitive conversational interfaces. Users are no longer required to navigate complex reports and dashboards. Instead, they can gain quick, aggregated insights from spend data for prompt decision-making across critical business domains, including procurement, budget management, and finance. Once the intent of spend analysis is identified, the application seamlessly receives, processes, and analyzes user queries related to financial transactions and expenditures. Some example scenarios for Spend analysis through conversational assistant includes receiving varied inputs from the users including a) Show me a summary of spending across various parameters such as Category, Region, Business Unit, Supplier, Payment Terms, and Diverse categories; b) Please detect anomalies in spending within specific areas; c) Identify opportunities for cost avoidance in Travel Spend; d) Share metrics like Supplier Diversity Spend, Contract Compliance, Inventory Turnover, and Spend by Supplier Performance, etc. All done on demand based on simple English based prompts written by users. For instance, when a user prompts, “Show me anomalies in spend with respect to MRO Category,” the application responds with a list of suppliers and items, providing detailed insights. The conversational assistance recommends potential areas and anomalies to user for exploring thereby not only providing on-demand insights but also proactively guiding users toward critical areas that require attention and deeper analysis through Generative AI.

Furthermore, when users focus on the intent of analyzing spend, the system goes beyond responsive interactions. It proactively recommends potential areas and anomalies for users to explore further. Examples of such interaction includes a) Maverick spending observed in the last quarter in the MRO category; b) Diverse spend reduced by more than 50% in the EMEA Region; c) Consulting & Professional Services spending increased by 170% compared to the previous year; d) 15 Payment Terms identified requiring rationalization.

In an exemplary embodiment, the data processing system and method facilitates opportunities within procurement, fundamentally transforming the landscape of cost optimization, strategic sourcing, and overall procurement efficiency. Utilizing conversational interfaces, users can pinpoint opportunities across various critical operational scenarios, including a) identifying Vendor Consolidation Opportunities by Category where the system enables detecting areas with an excess number of suppliers in specific category groups and recommend methods for consolidation. The application even facilitates the direct drafting of Requests for Proposal (RFPs) from this interface; b) recommending payment term normalization opportunities to ensure consistency and efficiency in financial transactions; c) proposing payment schedule for specific supplier to enhance financial planning and collaboration; d) highlighting request and Order consolidation opportunities for streamlining procurement processes and optimizing costs. In addition to user-initiated queries, the application autonomously learns from the extensive data in the Data store. It proactively analyzes data based on predefined parameters to uncover opportunities for savings, cost reduction, and efficiency enhancements without explicit user requests. The system identifies user patterns and personas, presenting actionable opportunities aligned with the user's responsibilities. For example, a) For Procurement Team it includes Cost Saving/Cost Avoidance Opportunities (e.g., Vendor consolidation, Payment term rationalization, Optimize Inventory levels, Price Benchmarking), Identification of Contractual Violations or KPIs not met per Project Milestones, Notification of Significant Drop in Supplier Performance (due to delayed delivery, increased returns, low post-order ratings, etc.), Opportunities for Demand/Purchase Request Aggregation; b) For Strategic Sourcing Manager it includes Inclusion Opportunities for Diverse Suppliers in Ongoing RFPs, Consolidation Opportunities for RFPs to Enhance Negotiation, Price Negotiation Opportunities based on Benchmarking, Sourcing Request and requisition aggregation Opportunities; c) For Category Manager it includes the Opportunities aligned specifically with the managed category, budget utilization highlights and projects nearing utilization limits, Contracts in Category nearing Expiry & Utilization limits; d) For Admin Users/Procurement Leads/CPO it includes identification of Missed Opportunities by Specific Personnel in Recent Months, and Summary View of all Currently identified Opportunities.

In an exemplary embodiment, the data processing system and method through intuitive conversational interface facilitates effortless navigation within the procurement landscape, identifying opportunities and streamlining the processes. The application goes beyond by presenting users with a comprehensive set of questions, ensuring not only a detailed understanding of user requirements but also guiding them through the correct buying channel, eliminating the need for lengthy form filling. The application offers an AI-powered seamless interaction experience with key features including a) Intent Assessment: By analyzing user prompts, the application identifies essential aspects of the purchase, including items, item categories, specifications, user's region, and organization (business unit), shipping details, supplier details, quantity, need-by date, contract/order reference, catalog/kit reference, and purchase history, etc. Some example prompts include: “I need to buy 100 40 mm roller bolts for the Alaska Plant” or “Request for a laptop” or “Lawn Mowing Service tomorrow” or “4 project managers for executing 405 Plant restructuring Project” or “repeat my order from yesterday” or “request for a personnel assistant for John Galt”. The application deploys Natural Language Processing (NLP) and Semantic analysis to break down the prompts, automatically generating a detailed request form on behalf of the user; b) Item recommendation from Catalog/Inventory: Based on the breakdown of identified elements, the application checks inventory availability and suggests requisition replenishment from the inventory upon approval. If the item is not available, it identifies whether it is present in hosted or punchout catalogs, allowing users to make selections directly; c) Recommending Vital Information: If the item is not found in the inventory or catalog, the application suggests suppliers, contracts, similar requests, and provides recommendations for vital information needed to complete the request (e.g., shipping, accounting). Users can make real-time changes within the chat interface; d) Identifying appropriate channels: Application identifies the correct Procurement channels for completing the purchase request based on company policy and procurement guidelines. Depending on the request channel identified a Purchase/Sourcing request is auto fills the mandatory information required by the process in the background. If the application identifies some information not available through cognitive intelligence, the same is suggested as a question with potential response options for user input; e) Auto-Submitting Purchase Requests and Automated Approval Workflows: The application streamlines the process by automatically submitting purchase requests and deploying automated approval workflows based on predefined spending thresholds for casual user purchases.

In a related embodiment, in addition to user-initiated actions, the application employs self-learning mechanisms to comprehend user preferences and patterns. Upon login, it autonomously presents opportunities and recommendations tailored to each user's buying behavior, including quick access to frequently purchased items; budget-friendly alternatives bundled discounts based on historical preferences; real-time notifications on budget utilization and remaining balances. This comprehensive approach guarantees that casual users enjoy a smooth, efficient, and personalized buying journey. By automating tasks and delivering intelligent insights, the application elevates the overall user experience, fostering user satisfaction, and optimizing procurement processes.

In yet another exemplary embodiment, the data processing system and method of the invention includes autonomous sourcing as a procurement function. Based on the nature of the item being requested by the user, the application automatically identifies the need to deploy a 3-bid buy process for the bid and auto-initiates the process on behalf of the user. In addition, the application can also initiate a 3-Bid Buy process, by analyzing intent from user prompts. Some Example Prompts include “Initiate a bid process for office supplies”; “Evaluate suppliers for IT equipment with a focus on cost and reliability”; “Complete the purchase of 100 units of Product X within budget constraints”. With the above example prompts, the application leverages the Procurement Objective Orchestrator/application process Orchestrator or the component to identify if there are other information elements required by the user to successfully execute the task stated in the prompt. For automated 3 Bid Buy or sourcing process, the application is configured to automatically suggests multiple things based on cognitive intelligence including a) List of items to be included in the Sourcing Event; b) Suggestive Questionnaire to assess the technical qualification of the supplier; c) Suggestive Contract Terms and conditions to be included; d) Potential Suppliers to be included in the RFP; e) Award Scenarios to automatically suggest supplier ranking based on responses.

The data processing system and method of the invention enables automated bid solicitation where the system autonomously identifies suppliers, builds an RFP template, and generates bid solicitations based on user requirements, industry standards, and historical data. Further, the system is configured for Supplier Engagement and Evaluation where through natural language interactions, the system engages suppliers, evaluates their capabilities, and considers past performance data using ML algorithms. Once supplier responses have been received, the application auto-analyzes the responses, compares the performance with the available data for each item and generates supplier feedback to allow suppliers to respond back with more competitive offers. In addition, the system also enables efficient negotiation techniques where the application further assesses any other negotiation techniques like different auction types for securing the best prices from suppliers by analyzing historical data, evaluating supplier performance, considering market conditions, and aligning with procurement objectives. Machine learning algorithms continuously adapt recommendations based on real-time insights, user input, and risk analysis. The application then dynamically evolves, providing actionable insights and simulations to enhance the effectiveness of procurement processes.

The data processing system also enables multiple Scenario Stimulation, whereby the application can simulate various negotiation scenarios by adjusting different parameters and inputs. This empowers the procurement team to analyze the potential consequences of different tactics, providing them with a strategic advantage in decision-making. The system also enables automated purchase recommendation where the system, leveraging continuous learning capabilities, independently formulates purchase decisions by evaluating predefined criteria, user preferences, and real-time data. Powered by Large Language Models, the conversational interfaces guide users seamlessly through the procurement process, offering instant information, detailed explanations, and educational content to enrich user comprehension of the system's supplier awarding recommendations. Following the recommendation phase, the application actively solicits user feedback and discerns any re-ranking parameters deemed necessary by the user. This iterative approach enables users to engage in straightforward conversations to better comprehend the awarding suggestions and adjust if needed. This user-friendly process eliminates the necessity for intensive analyses of supplier responses, enhancing overall user experience and ensuring a more refined procurement outcome. By combining the capabilities of AI and LLM, the system not only recommends negotiation tactics but also facilitates a dynamic, data-driven, and user-friendly approach to sourcing events. The continuous learning aspect ensures that the system evolves and improves its recommendations over time based on real-world feedback and outcomes.

In an example embodiment, the data processing system and method of the invention enables authoring of a contract and intelligent template generation in accordance with an embodiment of the invention. Contract authoring leverages Generative AI and Large Language Models (LLM) to revolutionize the creation of contract language templates. The system intelligently interprets user inputs, generating dynamic templates tailored to specific contractual requirements. Through innovative prompts like “Create a service level agreement for IT support with emphasis on responsiveness” or “Draft a purchase contract for customized products within budget constraints,” the application's “Contract Authoring Orchestrator” component employs generative AI to propose comprehensive contract terms, conditions, and clauses. The application also suggests risk meters for each clause in the contract and suggests alterations based on Supplier 360-degree performance. Some of the actions to be executed are analyzed by the Procurement Process Orchestrator under Contracts. For example, the prompts include “Create an MSA for Quanta for Marketing Consulting Service”, “Initiate Amendment of Global Contracts Expiring this year”, “Create an NDA for a prospective Vendor in Recruitment space”, “Show me all clauses with existing contracts with Indemnity Clause”.

In an advantageous aspect, the data processing system and method of the invention enables utilization of Generative AI to effectively identify type of contracts, and associated meta data required for generating that specific type of contract based on user prompts. The application based on this identified meta data, presents the users with the opportunity to change the meta data to then suggest pre-define clauses, recommended legal language to be included in the contract, recommended milestones and terms of payments. Based on information available in data lake/Knowledge bank & prior contracts, application also identifies potential line items and suggested prices based on information for each line item to eliminate the need of extreme intervention from the end user. The system also enables Intelligent Clause Suggestions where, by understanding the intent behind user requests, the application dynamically suggests relevant contract clauses, ensuring completeness and compliance. For instance, when prompted to “Create a nondisclosure agreement for technology collaborations,” the system intelligently incorporates clauses related to confidentiality, intellectual property, and dispute resolution. This process even continues when the user is reviewing the contract. Missing important clauses are highlighted with example text for the user to quickly incorporate. The system further enables Legal Compliance Checks during review as the system incorporates legal knowledge databases and real-time updates to ensure contract language aligns with current regulations and industry standards. It proactively identifies potential compliance issues and offers alternative language to mitigate risks. In addition, the data processing system also generates a risk meter on the interface where the application analyzes risk for each clause in the contract language on multiple parameters and recommends users to add certain clauses to lower the risks. Some Category of clauses analyzed includes but are not limited to Contractual ambiguity, financial risks, performance and Delivery Risks, Intellectual Property Risks, Termination and Exit Risks, Confidentiality and Data Security Risks, Force Majeure Risks, Dispute Resolution Risks, Vendor Related Risks, Geopolitical Risks, Market & Economic Risks, and Compliance Risks etc.

FIGS. 8, 8A, and 8B, shows an electronic user interface screen 800 of the data processing system having a chatbot for conversation orchestration to execute contract creation task in accordance with an example embodiment of the invention. The interfaces (800, 800A, 800B) show a conversational chatbot enabling a user to create a contract. The chatbot with domain specific back end LLM agents executes the task identified from the text received as input at the interface screen. In this example embodiment, the LLM agent generates multiple clauses of a contract for a user. Further, in the case of supply chain domain, there are multiple scenarios to be considered with multiple sub applications that impact the content of a contract. For eg: Purchase Order, Invoice amount, transportation details, warehouse management etc. Since, the data processing system of the present invention includes a Master Controller LLM agent interacting with multiple micro LLM agents trained on sub applications associated with the one or more supply chain application developed by a codeless platform, the learnings of the LLM agent enables execution of specific tasks as well. In case the input received is specific about creating a contract with XYZ supplier for purchase of any items for an amount $10000 based on the earlier contracts, the LLM agent will be able to interact with the data processing system to fetch out the clauses based on the learning of each of the one or more LLM agents and tie it to the intent of the user received through the interface.

Referring to FIG. 8C, a user interface 800C of a contract module persona of the data processing system in accordance with an example embodiment of the invention. The data processing system of the invention provides self-identification of areas for user attention and action based on user pattern and persona. The application autonomously presents opportunities and recommendations tailored to each user's behavior, allowing users to execute tasks without even initiating Prompts, such as, Contracts under authoring/review with high-risk scores, Contracts expiring in next 3 months, Contracts pending approval/language review, Potential risks identified in effective contracts etc.

In an exemplary embodiment, the data processing system and method of the invention supports conversational reporting system representing a significant advancement in user experience, allowing seamless access and insights from data without requiring users to navigate the intricacies of the reporting tool. Tailored for casual users, the application incorporates AI-powered features, including Intent Detection, Dashboard Creation, Making Edits to reports, Summarization, and Unstructured Analysis. Users can now effortlessly interact with the reporting tool, make aesthetic adjustments, and derive insights from both structured and unstructured data, marking a paradigm shift in data interaction. The conversational reporting feature redefines how users interact with and derive insights from their data, prioritizing user experience and empowerment. The system introduces several AI-powered features to enhance user interaction including a) Intent Detection where an application user interacts at two levels, identifying the desire to investigate or create reports and determining the appropriate data source for effective prompt resolution. Data Source could either be linked to the data generated from the procurement system or from data sources uploaded by the user or from combination of both. B) Dashboard Creation where, leveraging cutting-edge AI capabilities, the system automatically identifies and populates key performance indicators (KPIs) on the dashboard based on user prompts. Relevant KPIs and reports are selected from GEP's repository, streamlining the dashboard creation process. c) Report Modifications where, empowering users with unprecedented control, this feature allows aesthetic adjustments to the dashboard, from altering visualization types to adding new widgets, enhancing overall user experience. d) Summarization feature elevates user interaction by converting specific widgets or the entire dashboard into text through Natural Language Processing (NLP). This makes information accessible to a diverse range of personas, fostering a deeper understanding of data. e) Unstructured analysis where supporting unstructured data incorporation, users can seamlessly upload PDF, PPT, or DOCX files. The system enables Q&A or summarization tasks on this unstructured data, expanding the utility and flexibility of the reporting tool.

In another exemplary embodiment, the data processing system and method of the invention provides Should-cost modeling application that enables supply chain teams to determine the true price of goods and services purchased at any given point in time. This application empowered with AI, provides improved visibility into cost drivers, greater savings, and better priced products. Sourcing Managers no longer need to rely on judgement while negotiating with suppliers, but they can get a true estimate of the cost of products that they want to procure by simple prompts. The data processing system and related solution empowers everyone from category managers to sourcing experts to finance executives by ability to create and view multi-layered, flexible cost breakdown structures capturing material, labor, processing, and overhead costs that are sensitive to price movements of market indices. Further, contrary to traditional cost management applications that require extensive training to develop skill set for navigating through complicated UI, Should-cost modeling application is empowered by conversational interaction capabilities that are easy to use and helps in deriving deeper actionable insights. It provides real time alerts and recommendations, comes up with predictive analytics to predict cost of new configurations, scenario analyzer, price and trend analyzer, and ability to integrate with sourcing and category workbench. Some scenarios where conversational AI-driven should cost modeling significantly adds value includes a) identifying savings opportunity in a Bulk Chemicals category for US region basis market indices fluctuation; b) when to source Hose Assembly for Chicago plant; c) provide me with a list of market indices to monitor cost fluctuations for MRO category; d) determine impact on MRO spend if steel index goes up by 5%; e) Identify anomalies in Industrial Supplies category spend for US region in last 6 months basis should cost information; f) determine baseline for a price sheet within Packaging Material sourcing event created by me today; g) alert me when should cost goes up by 5% for steel plate heat exchanger in US Region; h) predict cost of deep groove ball bearings of 2 mm bore diameter, 7 mm outside diameter and 2.8 mm width for Houston plant. Further, based on the user persona, the application also identifies the actionable insights that can be acted upon. The system autonomously presents actionable insights and recommendations tailored to each user's behavior, enabling users to execute multiple tasks without even initiating Prompts. The tasks may include savings opportunities identification for products/services within a category and a region, recommendations on proactive sourcing basis real time forecasting and cost evolution, alerts during sourcing awarding when to be awarded price is exceeding should cost benchmark beyond certain threshold.

In another related embodiment, the data processing system enables enhanced inventory/warehouse operational efficiency. The Should-cost modeling application enables supply chain teams to determine the true price of goods and services purchased at any given point in time. This innovative application empowered with AI, provides improved visibility into cost drivers, greater savings, and better priced products. Sourcing Managers no longer need to rely on judgement while negotiating with suppliers, but they can get a true estimate of the cost of products that they want to procure by simple prompts. The solution empowers everyone from category managers to sourcing experts to finance executives by ability to create and view multi-layered, flexible cost breakdown structures capturing material, labor, processing, and overhead costs that are sensitive to price movements of market indices.

In an embodiment, the data processing system and method of the invention enables intent identification as a supply chain scenario for executing a task. The system predicts supply chain scenarios intended to be executed by the user as the at least one task, the bot identifies one or more nodes of a data network and associated data elements in the codeless platform linked to the at least one task for parsing the intent. The supply chain scenario includes processing by an AI engine coupled to a processor, a plurality of historical supply chain data from a data lake based on one or more supply chain data models to generate code for a recommended strategy to execute the at least one task through prediction analysis. Further the data processing method in the supply chain scenario for execution of the task includes injecting by an intelligent bot, aggregated supply chain data patterns related to the one or more data objects into the recommended strategy, identifying one or more entities for executing the recommended strategy; and encapsulating the one or more supply chain scenarios on the GUI for selection. Further, the operational function is executed by a user based on user profile where the users have abstraction-based access control to one or more documents of a data network for executing the function. The data processing system enables multi-tier centralized supply chain model. The system provides multi-tier multi-party supply chain capability where multiple parties are involved in performing various roles in the process such as Shipper, Receiver, Supplier, Customer, Inventory Storage Provider, Carrier, etc. depending on the enterprise specific business workflow. The Supply chain system supports multiple-party enablement in various documents such as Customer Orders, Supplier Orders, Inbound Shipments, Outbound Shipments etc., to provide visibility and collaboration to ensure smooth execution of the supply chain business process. The data processing system also includes modelling a network by a network builder configured to associate different relationship between organizations based on the user profile including buyer, supplier, shipper, receiver, carrier, payer, or payee to ensure validations of transaction and synchronization.

In a related aspect, the data processing system of the invention enables multi-party supply chain for forward and reverse logistics. The mandates of modern supply chain require enabling the business processes with multiple enterprises with multiple parties who are specialized in a specific supply chain business function. For example, the parties involved in Forward Logistics could totally be different to the parties involved in reverse logistics business process, as the reverse logistics deal with faulty/incorrect items that needs to be either repaired or refurbished it goes back into the useful Inventory. Often, this is common in large retail supply chain stores where when you buy from a retail store, you will not return to the store itself but will return to a different return-to service provider for the retail store who deal with faulty Items. Hence it becomes mandatory to support multi-party for the validation of the proper forward logistics documents with the return-to service provider details duly identified. In a typical supplier order, it may contain multiple parties and it is not always mandatory for a Shipper of the material for the forward logistics process to be the Return-To of the material also i.e they may not belong to the same enterprise. Hence, the forward logistics order such as the purchase order need to carry the Return-To party detail which may or may not belong to the Supplier or Shipper organization but may be a partner to those enterprises. The enabling multi-party framework of the data processing system provides a second nature approach to model the operational partners as trading partners as their own enterprises rather than rolling them under either the Supplier or Buyer enterprise as it used to be in the traditional supply chain systems.

In an advantageous aspect, the data processing system of the invention enables third party supply chain payment or Finance capabilities where the system acts as brokers in orchestrating the supply-demand balancing process.

Referring to FIG. 9, a user interface 900 showing real time shipment tracking and multi-model shipment tracking is provided in accordance with an example embodiment of the invention. The multi-party supply chain framework of the data processing system provides unique capability to define operational relationship through the Trading Partner Network relationship to ensure visibility of governing documents and the visibility of shipment tracking.

In an exemplary embodiment, the data processing system and method of the invention enables Generative AI based ad hoc queries enablement. The system introduces a user-friendly approach to complex ad hoc query requirements for various user personas. Different personas require different levels of aggregation and disaggregation of information at various levels depending upon the role the enterprise plays in the process. Hence an intuitive AI based Adhoc natural conversational query that a system can understand with the modern supply chain lingos and able to provide data outputs based on the privilege of the user's persona as well as the different levels of aggregation that cannot be pre-determined and pre-built. Some Example prompts include “Please show all Supply Demand mismatch for the next four Quarters for my category”; “Please show all Supply Demand mismatch for the next four months at Dallas location”; “Show me the aggregated monthly mismatch between supply and demand that is over 15%”; “Show me the Suppliers who are late in their shipments for the last four weeks”; “Please show all supplier orders where the promise is later than the need by date by more than five days that is due in the next four weeks”.

In a related embodiment, the data processing system and method of the invention enabling multi-party and multi-tier collaboration includes trading partner and network. The concept of abstraction is implemented at any Supply chain node. Any Information flow may be viewed by Buyer, Supplier, Carrier, Logistics Service Provider, Shipper, Receiver, etc. Based on the role they play in any of the document and the privileges associated with the role they play to progress the execution of the document for business goal. The users of these Trading partners can be enabled to have access control based on the enterprise hierarchy/Locations and the business functions they perform. Further, the system enables the capability to model a network using the network builder and associate different relationship between organizations based on the role they play in the Supply Chain business function such as Buyer, Supplier, Shipper, Receiver, Carrier, Payer, Payee, etc., to ensure validations of appropriate transaction communications and synchronization.

Referring to FIG. 10, a table 1000 showing how the data processing system creates a Supply Chain application by assembling the units of work of Codeless platform is provided in accordance with an example embodiment of the invention. For purchase order (PO), Collaboration application, the units of work include PO Generation, PO Modification, Supplier Confirmation, Communication Tools (Email, Alerts, Notifications), ERP Integration, PO Tracking. For Forecast Collaboration as application, the unit of work includes forecast Creation, Forecast Sharing, Collaborative Editing, Feedback Mechanism, Variance Analysis, Automated Reporting (Performance). For Capacity Collaboration as application, the unit of work includes (Capacity) Data Collection, Capacity Visualization, allocation Tool, adjustment mechanism. For Quality Management as application, the unit of work includes standards definition, Compliance Monitoring, Inspection Management, Issue Tracking and Resolution. For inventory management application, the unit of work includes inventory level monitoring, reorder point calculation, warehouse Layout Optimization, Stock Location Management. For demand planning application, the unit of work includes demand forecasting, trend analysis, collaborative forecasting, demand Plan Adjustment. For supply planning application, the unit of work includes Supply Chain Modeling, inventory optimization, supplier scheduling, order management. For should Cost Modeling application, the unit of work includes Cost Element Analysis, Cost Estimation Model, Market Price Tracking, input Cost Analysis. For transportation management application, the unit of work includes route planning, Load Optimization, carrier Selection, and Shipment Tracking.

Referring to FIG. 11, a graphical user interface (GUI) 1100 with a conversational assistant for application development or restructuring is provided in accordance with an embodiment of the invention. Since, the application are developed or restructure based on the codeless platform, the artificial intelligence is applied to multiple components including domain model, the state machine, application orchestrator, page designer, approval engine and development lifecycle. The data processing system and method of the invention enables users to define the data and logic of the application using natural language. For example, the user can input “I want to create a customer database with name, email, phone, and address fields” and the system will generate the corresponding code and schema for the database. Further, the data processing system enables user to control the flow and transitions of the application using NLP. For example, the user can input “I want to create a new status Submitted from the Created state for a document” and the system will generate the corresponding status and logic for the state machine. Also, the system enables users to coordinate the interactions and events of the application using natural language. For example, the user can input “I want the application to send an email confirmation to the user after they submit their order, and then update the inventory and the order status” and the system will generate the corresponding code and logic for the application orchestrator. The system is configured to enable users to create the user interface and layout of the application using natural language. For example, the user can input “I want the application to have a simple and elegant design, with a header, a footer, and a sidebar” and the invention will generate the corresponding metadata and layout for the page designer.

In a related aspect, the data processing system enables users to manage the permissions and approvals of the application using natural language. For example, the user can input “I want the application to require the manager's approval before processing any refunds, and to notify the customer and the accountant after the approval” and the system will generate the corresponding code and logic for the approval engine. Further the system enables users to plan, develop, test, deploy, and maintain the application using natural language. For example, the user can input “I want to generate automated test cases to validate my runtime system” and the system will generate the corresponding code and tasks for the development cycle.

In an exemplary embodiment, the data processing system and method of the invention enables integration through generative AI. The system is configured to execute complex integrations between one or more procurement systems and other ERP systems. By utilizing natural language prompts, users can independently initiate, complete, and manage system integrations without relying on IT teams. The conversational interface guides users through a seamless integration process, involving identification of integration intent, specification of integration details, and a streamlined review, test, and deployment phase. The system leverages deep learning to continuously enhance its recommendations based on user actions and preferences. Simple Prompts can initiate a conversational flow between the application and user allowing the user to complete the integration process from start to finish in a few simple steps.

Traditional ERP integrations often require extensive IT involvement, leading to delays and complexities. This invention addresses this challenge by introducing an intelligent conversational integration system that empowers users to effortlessly integrate one or more application procurement modules with other ERP systems. Some of the key features include a) Integration Intent Identification & Breakdown where application identifies the following to initiate the next steps of the integration, Procurement Module requiring integration (Ex: Purchase Request, Invoice, Orders, etc.) Target ERP application, Integration template. If the provided prompts do not contain information to identify any of these parameters, the application will provide intelligent suggestions for the user to choose from. b) Integration details where, based on the identified template, application requests the user to specify integration authentication details and Field Level Mappings. Field mappings between the source and target systems are automatically suggested by the application based on semantic analytics and AI. However, the user will have the ability to overwrite the same. c) Review, Test and Publish, where the Users can then review all the integration details from this chat interface itself, test integrations and based on successful test runs, deploy & publish the integrations from this very same interface. Eliminating the need of going through complex interfaces of Ipaas (Integration Platform as a Service) solutions for integrating GEP systems with legacy ERP & other software. d) Continuous Learning where the application deploys deep learning techniques to constantly learn from user actions on given recommendations and continuously learn from behavior and patterns to provide more intelligent suggestions based on this information. For example, “Integrate Orders with my ERP”, “Outbound Invoices to ERP XYZ”, “Integrate Field Glass requisitions from ERP XYZ S6”, “Show Outbound Invoice Mapping details from GEP application to S6”. This conversational integration system revolutionizes the integration landscape, offering users a user-friendly and autonomous approach to GEP procurement and legacy ERP system integrations. The continuous learning aspect ensures that the system remains adaptive, efficient, and aligned with evolving user needs.

Referring to FIG. 12, a user interface 1200 with a conversational assistant configured for executing application integration tasks in accordance with an embodiment of the invention. The user interface shows selection of application XYZ S6 for integration with the application. It also shows the requisition master data and transaction data is to be integrated with the application. Based on the selection, the Artificial intelligence-based data processing system recommends the integrations as shown by interface 1200A in FIG. 12A.

Referring to FIG. 12B a user interface 1200B showing deployment of integration of one application with another ERP application in accordance with an example embodiment of the invention. The user interface 1200B shows additional parameters tuned for deploying the integration.

Referring to FIG. 12C, a user interface 1200C depicting supplier integration of master data and transaction data of one application with another enterprise application is shown in accordance with an example embodiment of the invention. The user interface 1200C shows multiple supplier integration through the platform.

In an exemplary embodiment, the data processing system enables the user to consume out-of-the-box template workflows to solve their integration needs. The AI Engine of the data processing system is trained to select and generate workflows based on the various prompts and templates. As an example, the user would interact with the conversational assistant and prompt the system that they would like to find available integrations for their operational scenarios. The system would identify the intent and ask the user to select their source and target systems. The intent of the user is parsed which includes predicting one or more application integration scenarios intended to be executed by the user as the at least one task, the bot identifies one or more nodes of a data network linked to the at least one task for parsing the intent. Further, the data processing method includes processing by an AI engine coupled to a processor, a plurality of historical application integration data from a data lake based on one or more integration data models to generate code to execute the at least one task through prediction analysis. The User can select from the options provided by the system or enter manually the details of the source and target systems. The system will then try to identify the selection by the user and ask them to provide information on the documents that they would like to integrate. Based on the inputs provided by the user, the system would recommend the template workflows that they can use. The user can select one or more of the template workflows. Based on the user selection, the system would ask the user to provide the configuration parameters required for those template workflows to run successfully. The user can choose to enter the configuration parameters within the conversational assistant window, or they can skip this step and submit. The system will then give the option for the user to create integrations or to create and deploy the integrations. The user will be navigated to the integrations page based on their selection.

In a related embodiment, the data processing system for integration of one application with another application utilizes automapping triggered by the AI engine. Mapping is the method of creating data transformation logic between source and target for the data being transmitted through interface. For example, in a scenario when data is received from a source system in a certain format, it is automatically transformed into a format that is understandable by the target system through Artificial intelligence AI engine. As an example, the user opens the conversational assistant/chat window and enters the prompt that they would like to update the mapping in their integration. Based on the integration details provided by the user, the system responds with one or more integrations that match the details. The system will request the user to select the integration that they intend to update the mapping. The user selects the integration in which they want to update the mapping. The AI engine checks if the integration has more than one mapping. If there is more than one mapping, the system identifies the mapping to be updated based on the AI engine. Once the mapping is identified, the Source and Target schemas are uploaded. If there is only one mapping, the user is asked to upload the Source and Target schemas. Once the user uploads the schemas, the AI engine determines the possible field to field mapping and provides the recommended mapping to the user and the mapping is updated into the integration. Further, if the user provides a Pseudocode mapping between Source and target, the data processing system utilizes the AI engine to generate the mapping.

In another related embodiment, the integration enables connectivity and transmission of data between two ERP systems. For workflow the system identifies the next connect to use when they are creation workflow. Further, the system provides recommendations on complex syntax when the user is creating the workflow. When the user wants to create a complex syntax such as a javascript code or a custom xslt logic, the system automatically generates a recommendation through the chat window for the user based on the application orchestrator. Further, the system fetches information about a document that was transmitted through a workflow using AI based processing.

In an advantageous aspect, the system enhances the scenario of low-code platforms by integrating conversational AI into the core components of the platforms. The conversational assistant with AI allows the users to design complex processes using natural language, instead of graphical notation. The users can describe their operational requirements, goals, and scenarios in natural language, and the conversational AI can translate them into LLM models. The conversational assistant also provides guidance, suggestions, and feedback to the users during the design phase, helping them to create optimal and valid operational processes. Further, conversational AI enables the users to publish their processes using natural language, instead of manual configuration. The users can specify their deployment options, such as target environment, tenant, and version, in natural language, and the conversational AI can execute the deployment process. The conversational AI can also provide status updates, notifications, and reports to the users during the publish phase, helping them to monitor and manage their business processes.

In an exemplary embodiment, the electronic user interface enables cognitive computing to improve interaction between user and the LLM based data processing system. The interface improves the ability of a user to use the computer machine itself. Since the interface triggers conversational response, it enables a user to interact with the chatbot seamlessly to execute the task. By eliminating unwanted domain specific interface elements, repetitive processing and recordation of information to get the desired data, which would be slow and complex the user interface is more user friendly and improves the functioning of the existing computer systems.

Further, in an exemplary embodiment, the codeless platform structuring applications with a low code framework enables developers to create applications by chaining multiple LLM agents trained and perfected to carry out specific tasks. The present invention creates a set of LLM agents each specializing in a specific task. These LLM agents are configured to be seamlessly bound together via chains (in a deterministic flow setting) for orchestrating the LLM agents and executing a task (in non-deterministic flow setting). These LLM agents are extensible, customizable and can carry out natural language conversations if required.

In an exemplary embodiment, the present invention may be a system, a method, and/or a computer program product. The computer program product may include a computer readable storage medium (or media) having computer readable program instructions thereon for causing a processor to carry out aspects of the present invention. The media has embodied therein, for instance, computer readable program code (instructions) to provide and facilitate the capabilities of the present disclosure. The article of manufacture (computer program product) can be included as a part of a computer system/computing device or as a separate product.

The computer readable storage medium can retain and store instructions for use by an instruction execution device i.e. it can be a tangible device. The computer readable storage medium may be, for example, but is not limited to, an electromagnetic storage device, an electronic storage device, an optical storage device, a semiconductor storage device, a magnetic storage device, or any suitable combination of the foregoing. A non-exhaustive list of more specific examples of the computer readable storage medium includes the following: a hard disk, a random access memory (RAM), a portable computer diskette, a read-only memory (ROM), a portable compact disc read-only memory (CD-ROM), an erasable programmable read-only memory (EPROM or Flash memory), a digital versatile disk (DVD), a static random access memory (SRAM), a floppy disk, a memory stick, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the internet, a local area network (LAN), a wide area network (WAN) and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

The foregoing is considered as illustrative only of the principles of the disclosure. Further, since numerous modifications and changes will readily occur to those skilled in the art, it is not desired to limit the disclosed subject matter to the exact construction and operation shown and described, and accordingly, all suitable modifications and equivalents may be resorted to that which falls within the scope of the appended claims.

1. A large language model-based data processing method for one or more applications developed by a codeless platform, the method comprising:
generating by a processing device, a graphical user interface (GUI) having a conversational assistant configured for receiving at least one input from a user;
determining an intent of the user based on one or more data objects identified from the received input wherein the conversation assistant is configured to generate one or more query in response to the received input until the intent of the user is identified by an intent analyzer;
triggering one or more LLM (large language model) agent for executing at least one task associated with the identified intent of the user wherein a process orchestrator invokes one or more tools identified by the LLM agent for executing the at least one task; and
generating on the GUI, one or more graphical elements depicting one or more actionable data points associated with the at least one executed task.

2. The method of claim 1, wherein the intent analyzer is a bot configured to parse the intent of the user based on the identified data objects and mapping the intent with the LLM agent, wherein one or more one data scripts are identified based on the parsed intent to trigger the at least one task.

3. The method of claim 2, further comprises a bot builder configured to process one or more historical data for generating and storing, training artifacts and flow artifacts in an intent database wherein the intent analyzer processes the received input based on one or more intent data models to identify the intent.

4. The method of claim 3, wherein the intent analyzer is configured to analyze the intent from the at least one received input by:
converting the received input into numerical representation through embeddings;
creating embeddings, one or more clusters during training and receiving sample prompts from users wherein each cluster represents a different intent; and
identifying cluster nearest to an embedding representation of the received input to determine the intent, wherein a generative AI based reasoning model enables mapping of the received input to the intent in case the embedding representation is equally close to different clusters.

5. The method of claim 4, wherein parsing intent of the user includes predicting one or more procurement scenarios intended to be executed by the user as the at least one task, the bot identifies one or more nodes of a data network linked to the at least one task for parsing the intent.

6. The method of claim 5, further comprises:
processing by an AI engine coupled to a processor, a plurality of historical procurement and user activity data from a data lake based on one or more procurement data models to generate code for a recommended strategy to execute the at least one task through prediction analysis.

7. The method of claim 6, further comprises:
injecting by an intelligent bot, aggregated user activity data and procurement data patterns related to one or more procurement categories into the recommended strategy;
identifying one or more suppliers for executing the recommended strategy; and
encapsulating one or more recommended supplier awarding scenario on the GUI for selection.

8. The method of claim 7, wherein the generative AI model is configured to interact through the conversational assistant to accurately guide the user towards the intent.

9. The method of claim 7, further comprises the steps of breaking down complex procurement objectives received as the input into one or more actionable tasks through semantic analysis wherein the one or more data models trained on procurement datasets enable analysis of real-time procurement data and trends to recommend strategy including corrections or adjustments to procurement strategy.

10. The method of claim 9, wherein the one or more procurement scenarios include spend analysis, sourcing, supplier management, opportunity identification, contract management, and negotiation as part of procurement operations.

11. The method of claim 10, wherein spend analysis includes:
generating summary of spend across various parameters such as category, region, entity operation unit, supplier, payment terms, and diverse categories;
detecting anomalies in spend within specific areas;
identifying opportunities for cost avoidance in travel spend; and
sharing metrics like Supplier diversity spend, Contract Compliance, Inventory Turnover, and Spend by Supplier Performance.

12. The method of claim 11, wherein the conversational assistance recommends potential areas and anomalies to user for exploring thereby not only providing on-demand insights but also proactively guiding users toward critical areas that require attention and deeper analysis through Generative AI.

13. The method of claim 10, wherein opportunity identification through generative AI and LLM based processing includes identifying vendor consolidation opportunities by category, identifying, and recommending payment term normalization opportunities, identifying, and proposing payment schedule for specific supplier, and identifying request and order consolidation opportunities.

14. The method of claim 4, wherein parsing intent of the user includes predicting one or more supply chain scenarios intended to be executed by the user as the at least one task, the bot identifies one or more nodes of a data network and associated data elements in the codeless platform linked to the at least one task for parsing the intent.

15. The method of claim 14, further comprises:
processing by an AI engine coupled to a processor, a plurality of historical supply chain data from a data lake based on one or more supply chain data models to generate code for a recommended strategy to execute the at least one task through prediction analysis.

16. The method of claim 15, further comprises:
injecting by an intelligent bot, aggregated supply chain data patterns related to the one or more data objects into the recommended strategy;
identifying one or more entities for executing the recommended strategy; and
encapsulating the one or more supply chain scenarios on the GUI for selection.

17. The method of claim 16, wherein the one or more supply chain scenarios include demand sensing, forward-reverse logistics, shipment tracking, as part of supply chain operations.

18. The method of claim 14, further comprises:
execution of operational function by a user based on user profile wherein the users have abstraction-based access control to one or more documents of a data network for executing the function.

19. The method of claim 18, further comprises:
modelling a network by a network builder configured to associate different relationship between organizations based on the user profile including buyer, supplier, shipper, receiver, carrier, payer, or payee to ensure validations of transaction and synchronization.

20. The method of claim 19, further comprising a multi-tier multi-party supply chain function execution through multi-party enablement in the one or more documents of the data network.

21. The method of claim 4, wherein parsing intent of the user includes predicting one or more application integration scenarios intended to be executed by the user as the at least one task, the bot identifies one or more nodes of a data network linked to the at least one task for parsing the intent.

22. The method of claim 21, further comprises:
processing by an AI engine coupled to a processor, a plurality of historical application integration data from a data lake based on one or more integration data models to generate code to execute the at least one task through prediction analysis.

23. The method of claim 22, further comprises:
identifying one or more entities, one or more application integration parameters, and the one or more integration data models from the data object for executing the at least one task of integration the one or more applications.

24. The method of claim 23, further comprises:
identifying source and target for executing the at least one task by automapping, wherein the automapping includes:
loading source and target files of syntax based structured data and extracting source path from a historical structured data database, and
tokenizing source path and fetching matching target paths from Inverted Index supported historical database for automapping source and target.

25. The method of claim 24, wherein matching includes:
converting each object of source to vector by word embedding;
computing dot products and magnitude of the vectors to determine similarity, and
determining similarity score for each object of target.

26. The method of claim 25, wherein
in response to determination of the application for integrations, generating one or more integration workflows by an intelligent bot;
identifying by the bot, one or more configuration parameters for integration, and
injecting by the bot, the configuration parameters into the one or more integration workflows for creating and deploying integration of the applications.

27. The method of claim 4, wherein parsing intent of the user includes predicting one or more application development or application restructuring scenarios intended to be executed by the user as the at least one task, the bot identifies one or more nodes of a data network linked to the at least one task for parsing the intent.

28. The method of claim 27, further comprises:
determining, by a processor, a requirement to restructure the one or more applications developed by a codeless platform as the at least one task;
identifying by the one or more tools, one or more logical flow blocks to be invoked by the processor for creating one or more SCM application operation logical fragments configured to restructure the one or more applications;
triggering a syntax data library by the processor, to enable the one or more tools to load one or more data library components on an extension tool interface for structuring the one or more logical flow blocks to create the one or more SCM application operation logical fragments;
and
restructuring the one or more applications by the one or more SCM application operation logical fragments to enable execution of at least one SCM application operation.

29. The method of claim 28, further comprises identifying by the processor, a plurality of configurable components of a layered codeless platform architecture based on the one or more LLM agent for restructuring one or more SCM applications to execute the SCM application operation, wherein the processor is coupled to an AI engine.

30. The method of claim 29, wherein the conversational assistant is configured to modify domain models, user interfaces, update code associated with new data elements, validate compatibility of the new data elements and recommend alternatives.

31. The method of claim 27, further comprises:
determining by a processor, a requirement to create one or more applications as the at least one task, wherein the one or more application is developed by a codeless platform; and
identifying by one or more tools, a plurality of configurable components invoked by the processor to be structured on a user interface for creating the one or more application;
wherein the plurality of configurable components interact through an application process orchestrator for executing the at least one task.

32. The method of claim 31, wherein the conversation assistant is configured to:
recommend one or more templates or components for customization of the one or more application;
define data structures, relationships and rules, data models and validation rules;
in response to a request for creating a user interface, recommend one or more interface components and generate a corresponding code for execution, and
recommend data patterns and explain behavior and effects of different orchestrations.

33. The method of claim 32, wherein the one or more LLM agent is configured to be trained in a distributed structure with artificial intelligence controllers wherein different parts of the one or more LLM agent are distributed across a plurality of Graphics processing units (GPU) for parallel training of the LLM agent.

34. The method of claim 32, wherein the conversations assistant is configured to enable execution of data operations, such as denormalization, aggregation, filtering, sorting, and grouping, creation of custom AI models, such as regression, classification, clustering, and anomaly detection, and generation of insights and predictions from the data.

35. The method of claim 1, wherein the conversation assistant is configured to receive a text, image or voice input wherein the image or voice input is converted to text by one or more processors for enabling the LLM agent to identify the intent of the user and the at least one task to be executed.

36. A large language model-based data processing system for one or more applications developed by a codeless platform, the method comprising:
one or more processors; and
one or more memory devices including instructions that are executable by the one or more processor for causing the processor to
generate a graphical user interface (GUI) having a conversational assistant configured for receiving at least one input from a user;
determine an intent of the user based on one or more data objects identified from the received input wherein the conversation assistant is configured to generate one or more query in response to the received input until the intent of the user is identified by an intent analyzer;
trigger one or more LLM (large language model) agent for executing at least one task associated with the identified intent of the user wherein a process orchestrator invokes one or more tools identified by the LLM agent for executing the at least one task; and
generate on the GUI, one or more graphical elements depicting one or more actionable data points associated with the at least one executed task.

37. The system of claim 36, wherein the intent analyzer is a bot configured to parse the intent of the user based on the identified data objects and mapping the intent with the LLM agent, wherein one or more one data scripts are identified based on the parsed intent to trigger the at least one task.

38. The system of claim 37, further comprises a bot builder configured to process one or more historical data for generating and storing, training artifacts and flow artifacts in an intent database wherein the intent analyzer processes the received input based on one or more intent data models to identify the intent.

39. The system of claim 38, wherein the intent analyzer is configured to analyze the intent from the at least one received input by:
converting the received input into numerical representation through embeddings;
creating embeddings, one or more clusters during training and receiving sample prompts from users wherein each cluster represents a different intent; and
identifying cluster nearest to an embedding representation of the received input to determine the intent, wherein a generative AI based reasoning model enables mapping of the received input to the intent in case the embedding representation is equally close to different clusters.

40. The system of claim 39, wherein parsing intent of the user includes predicting one or more procurement scenarios intended to be executed by the user as the at least one task, the bot identifies one or more nodes of a data network linked to the at least one task for parsing the intent.

41. The system of claim 39, wherein the codeless platform includes:
a plurality of configurable components; a customization layer; an application layer; a shared framework layer; a foundation layer; a data layer; and an application orchestrator;
wherein the at least one processor is configured to cause the plurality of configurable components to interact with each other in a layered architecture to:
customize the one or more application based on at least one operation to be executed using the customization layer;
organize at least one application service of the one or more application by causing the application layer to interact with the customization layer through one or more configurable components of the plurality of configurable components, wherein the application layer is configured to organize the at least one application service of the one or more application;
fetch shared data objects to enable execution of the at least one application service by causing the shared framework layer to communicate with the application layer through one or more configurable components of the plurality of configurable components, wherein the shared framework layer is configured to fetch the shared data objects to enable execution of the at least one application service, wherein fetching of the shared data objects is enabled via the foundation layer communicating with the shared framework layer, wherein the foundation layer is configured for infrastructure development through the one or more configurable components of the plurality of configurable components;
manage database native queries mapped to that at least one operation using a data layer to communicate with the foundation layer through one or more configurable components of the plurality of configurable components, wherein the data layer is configured to manage database native queries mapped to the at least one operation; and
execute the at least one operation and develop the one or more application using the application orchestrator to enable interaction of the plurality of configurable components in the layered architecture.

42. The system of claim 41, further comprises:
a data network configured for storing and processing of one or more dataset of the one or more application developed by the codeless platform, wherein a data network server is configured to receive the one or more dataset from a plurality of data source for structuring a multi-tier multi-party enabled data network;
one or more data element nodes configured to create one or more sub-network through a graphical data structure wherein one or more data elements are extracted from the one or more dataset for relationship analysis to identify the one or more data elements to be ingested as one or more data element node of the data network; and
one or more data connectors of the graphical data structure configured for connecting the one or more data element node to form the data network.

43. The system of claim 42, wherein the user interface includes an input component configured to receive the input, wherein the input component is a chatbot configured to receive a text, image or voice input wherein the image or voice input is converted to text by one or more processors for enabling the LLM agent to identify the intent of the user and the at least one task to be executed.

44. The system of claim 43, wherein different parts of the LLM agent are distributed across a plurality of GPU (Graphics processing Units) for parallel training including data parallelism, sequence parallelism, pipeline parallelism and tensor parallelism.

45. A computer program product comprising a non-transitory computer readable storage medium that causes a processor to:
generate a graphical user interface (GUI) having a conversational assistant configured for receiving at least one input from a user;
determine an intent of the user based on one or more data objects identified from the received input wherein the conversation assistant is configured to generate one or more query in response to the received input until the intent of the user is identified by an intent analyzer;
trigger one or more LLM (large language model) agent for executing at least one task associated with the identified intent of the user wherein a process orchestrator invokes one or more tools identified by the LLM agent for executing the at least one task; and
generate on the GUI, one or more graphical elements depicting one or more actionable data points associated with the at least one executed task.
